(19) United States
(12) Patent Application Publication
(10) Pub. No.: US 2011/0044736 A1
(43) Pub. Date: Feb. 24, 2011

(54) HEAT GENERATING UNIT AND HEATING APPARATUS

(75) Inventors: Masanori Konishi, Kagawa (JP); Akira Nishio, Kagawa (JP); Hiroaki Matsuoka, Kagawa (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/990,767

(22) PCT Filed: Dec. 19, 2008
(86) PCT No.: PCT/JP2008/003860

§ 371 Date: Nov. 2, 2010

(30) Foreign Application Priority Data
May 9, 2008 (JP) 2008-123396 2008
May 9, 2008 (JP) 2008-123408 2008

(51) Int. Cl. G03G 15/20; H05B 3/02

(52) U.S. Cl. 399/328; 219/538

(57) ABSTRACT

A heat generating unit of the present invention is formed such that: a band-like heat generating element (2) formed with a film sheet raw material of a material including a carbon-based substance and having a two-dimensional isotropic thermal conduction is enclosed in a container (1); and heat generating element holder portions (2a) at end portions of the heat generating element (2) are held by retainers (3). The retainers (3) are each structured to have a hook-received portion (3a) around which corresponding heat generating element holder portion (2a) is wrapped, a hook portion (3b) attached to the hook-received portion (3a) so as to clamp the heat generating element holder portion (2a), and an engagement-stop portion (3c) extending from the hook-received portion (3a) to engagingly stop the heat generating element holder portion (2a).

### TECHNICAL FIELD

The present invention relates to a heat generating unit used as a heat source and to a heating apparatus using the heat generating unit. In particular, the present invention relates to a heat generating unit having a heat generating element formed in a film sheet shape by employing a carbon-based substance as its main component, and to a heating apparatus using the heat generating unit. The heating apparatus according to the present invention includes a variety of appliances that require a heat source, e.g., electronic devices such as a copying machine, a facsimile, a printer and the like, and electric appliances such as an electric space-heating appliance, a cooking appliance, a drying machine and the like.

### BACKGROUND ART

As described above, the heat generating unit is used in a variety of appliances as a heat source. Accordingly, the heat generating unit is required to satisfy various requirements so as to meet the specifications, such as functions, shapes, structures, of the appliance with which the heat generating unit is used. For example, there are the requirements such as achieving high temperatures as a heat source, maintaining a specified temperature, having a wide temperature adjustment range, capability of converting the input electric power into the heating energy with high efficiency, capability of uniformly heating target object, having the directivity for heating only in the specified direction, inviting little occurrence of an inrush current when power is turned on, having a short start-up time until reaching a set temperature, and achieving a structure which makes it possible to miniaturize the heat generating unit, while achieving easier removal or attachment of the heat generating unit.

In order to meet the requirements as stated above, a variety of heat generating units have been proposed.

The conventional heat generating units each being an elongate shaped heat source is structured by having an elongated coil-shaped tungsten wire, or a rod-like or plate-like carbon-based sintered compact enclosed inside a cylindrical glass tube as a heat generating element. Recently, replacing such heat generating elements, what have been provided are the ones that use, as a versatile heat generating unit that can heat a heating target object more uniformly and to even higher temperatures, an elongated sheet-like (band-like) heat generating element obtained by impregnating fibers whose main component is a carbon-based substance with resin, and subjecting the same to a temperature treatment.

In the heat generating unit, to both end portions of the heat generating element accommodated inside the glass tube, members for supplying power (power supplying members) are respectively attached. It is necessary to structure the power supplying members so as to be surely attached to the heat generating element, and to be capable of supplying power with high efficiency. Further, because the heat generating element and the power supplying members in the heat generating unit are structured to be disposed at prescribed positions inside the narrow and fragile glass tube and to be enclosed therein, the manufacture of the heat generating unit must achieve production of a structure being excellent in workability, which allows the heat generating element and the power supplying members to be assembled easily and surely inside the glass tube. Still further, as for the heat generating unit used as a heat source, a device possessing great safety and reliability and capable of enduring a long period of use is an absolute requisite.

### CITATION LIST

### Patent Literatures

PLT 1: Japanese Unexamined Patent Publication No. 2004-193130
PLT 2: Japanese Unexamined Patent Publication No. 2006-040898
PLT 3: Japanese Unexamined Patent Publication No. 2005-116412
PLT 4: Japanese Unexamined Patent Publication No. 2005-149809

### SUMMARY OF INVENTION

### Technical Problem

Among the conventional heat generating units using the elongated sheet-like (band-like) heat generating element obtained by impregnating fibers whose main component is a carbon-based substance with resin, and subjecting the same to the temperature treatment, what are available are the ones obtained by having both end portions of the heat generating element coated with noble metal; covering the coated portions by metal sleeves; and brazing the metal sleeves and the covered portions with a brazing metal (see Japanese Unexamined Patent Publication No. 2004-193130). Such a method of welding the heat generating elements and the metal sleeves with the brazing metal invites melting of the brazed portions caused by heat conduction from the heat generating element in a heat generating unit where the heat generating element reaches a high temperature (for example, 1100° C.), which, in some cases, causes the heat generating element to come off, posing a serious problem in terms of safety.

Further, among the conventional heat generating units, what are available are the ones having a structure having power supplying members fixed by use of pressure to both end portions of an elongated sheet-like heat generating element (see Japanese Unexamined Patent Publication No. 2006-040898). The conventional heat generating units structured in this manner use a heat generating element obtained by securely fixing by use of resin a plurality of carbon fibers in a sheet-like shape. The sheet-like heat generating element in the conventional heat generating units structured in this manner has a smooth surface. Therefore, when the power supplying members lack a strong clamping force, the heat generating element may possibly come off from the power supplying members, posing a problem of its being unreliable.

The inventors of the present invention have worked on developing a heat generating unit implementing a novel heat source, with a heat generating element adopting a novel film sheet-like material as the heat generating material. This film sheet-like material is completely different in material and manufacturing method from the sheet-like heat generating element whose main component is a carbon-based substance, which is used in the conventional heat generating units. The novel film sheet-like material to be adopted as the heat generating element used in the heat generating unit has the surface further smoother than that of the conventional heat generating element, and is pliable. Further, this film sheet-like material does not exhibit great strength and, therefore, it may possibly be torn and destroyed under application of a great force. Accordingly, use of the novel film sheet-like material as a heat generating element so as to structure a heat generating unit by adopting the structure of the power supplying members in the above-described conventional heat generating unit poses a problem in terms of safety and reliability.

An object of the present invention is to allow a heat generating unit and a heating apparatus implementing a high-efficient heat source capable of heating a heating target object with a desired heat generation and to high temperatures to have a structure that possesses great safety and reliability, and that can easily be manufactured. As a result, according to the present invention, it becomes possible to provide the heat generating unit and the heating apparatus possessing great safety and reliability, and capable of being manufactured with ease.

It is to be noted that, in the present invention, a heating apparatus using a heat generating unit as a heat source includes an image fixing device, and an image forming device provided with the image fixing device. Examples of the image forming device include appliances that require a heat source, such as copying machines, facsimile machines, printer devices, and multifunction peripherals provided with the functions of the foregoing devices.

What is used in an image forming process carried out by the image forming device is the image fixing device that pressurizes a recording target member, e.g., a paper, which carries an unfixed toner image, and that heats the same at high temperatures to thereby fix the image.

A heat generating unit is used as the heat source of the image fixing device. Examples of the conventional heat generating unit used in the image fixing device are a halogen heater that uses a heat generating element formed with a tungsten material, or a carbon heater that uses an elongated plate-like heat generating element formed with a mixture of crystallized carbon such as graphite, a resistance value regulating material, and an amorphous carbon (see Japanese Unexamined Patent Publication Nos. 2005-116412 and 2005-149809).

The present invention has been made to provide, by use of the heat generating unit achieving the above-described objects, an image fixing device and an image forming device having a heat source that can heat a heating target object with a desired heat distribution at high temperatures with high efficiency in the fixing process, and that starts up quickly, being capable of reducing the energy consumption.

### Solution to Problem

In order to solve the problems associated with the conventional heat generating unit and to achieve the object of the present invention, a heat generating unit according to a first aspect of the present invention includes:

a band-like heat generating element that is formed with a film sheet of a material including a carbon-based substance and that has a two-dimensional isotropic thermal conduction;

power supply portions that supply electric power to opposing both ends of the heat generating element; and

a container that contains the heat generating element and part of the power supply portions, wherein

the power supply portions inside the container each have a retainer that holds a heat generating element holder portion located at each of both the ends of the heat generating element, and an internal lead wire portion connected to the retainer, the retainer being structured to have a hook-received portion having the heat generating element holder portion wrapped around, an engagement-stop portion extending from the hook-received portion so as to engagingly stop the heat generating element, and a hook portion attached to the hook-received portion so as to clamp the heat generating element holder portion. The heat generating unit according to the first aspect of the present invention structured in this manner implements a heat source that is capable of heating a heating target object with a desired heat distribution pattern to high temperatures, possessing great safety and reliability, exhibiting high efficiency, and having a structure that can be manufactured with ease.

In the heat generating unit according to a second aspect of the present invention, in the hook-received portion according to the first aspect, a site bearing the heat generating element holder portion extends in a width direction perpendicular to a longitudinal direction of the heat generating element. In the heat generating unit according to the second aspect of the present invention structured in this manner, the heat generating element is surely engagingly stopped by the retainers without coming off, whereby a heat source of a simplified structure possessing great safety and reliability is implemented.

In the heat generating unit according to a third aspect of the present invention, one of a hole and a notch is formed at the heat generating element holder portion according to the second aspect, and the engagement-stop portion is disposed inside one of the hole and the notch. The heat generating unit according to the third aspect of the present invention structured in this manner implements a heat source having a simplified structure that can be manufactured with ease.

In the heat generating unit according to a fourth aspect of the present invention, the engagement-stop portion disposed inside one of the hole and the notch according to the third aspect is joined to the internal lead wire portion. The heat generating unit according to the fourth aspect of the present invention structured in this manner implements a heat source having a simplified structure that can be manufactured with ease.

In the heat generating unit according to a fifth aspect of the present invention, the hook-received portion and the engagement-stop portion according to the fourth aspect are integrally formed with a wire material, the hook-received portion being structured by the wire material being bent so as to allow the heat generating element holder portion to be wrapped around, and the engagement-stop portion being structured to lead to the internal lead wire portion. The heat generating unit according to the fifth aspect of the present invention structured in this manner implements a heat source having a simplified structure that can be manufactured with ease.

In the heat generating unit according to a sixth aspect of the present invention, the hook-received portion and the engagement-stop portion according to the fourth aspect are integrally formed with a wire material, the engagement-stop portion being disposed inside the notch formed at an edge portion in the width direction of the heat generating element holder portion. The heat generating unit according to the sixth aspect of the present invention structured in this manner implements a heat source having a simplified structure that can be manufactured with ease.

In the heat generating unit according to a seventh aspect of the present invention, the hook-received portion and the engagement-stop portion according to the first aspect are formed with a single wire material, the hook-received portion and the engagement-stop portion being formed by the wire material being bent. The heat generating unit according to the seventh aspect of the present invention structured in this manner implements a heat source having a simplified structure that can be manufactured with ease.

In the heat generating unit according to an eighth aspect of the present invention, the hook portion according to the first aspect is formed with an elastic material, the hook portion being structured so as to be attached to the hook-received portion by an elastic force. The heat generating unit according to the eighth aspect of the present invention structured in this manner makes it possible to easily and surely fix the heat generating element to the hook-received portion. Thus, a heat source possessing great safety and reliability can easily be manufactured.

In the heat generating unit according to a ninth aspect of the present invention, the hook-received portion according to the first aspect is formed with an electrically conductive material. The heat generating unit according to the ninth aspect of the present invention structured in this manner secures the power supply to the heat generating element, whereby it becomes possible to provide a heat source possessing great reliability.

In the heat generating unit according to a tenth aspect of the present invention, the retainer according to the first aspect has a position regulating function for disposing the heat generating element at a prescribed position inside the container, an end portion in the retainer being disposed close to an internal surface of the container. The heat generating unit according to the tenth aspect of the present invention structured in this manner allows the heat generating element to be disposed at a desired position inside the container, whereby it becomes possible to provide a heat source possessing great safety and reliability.

In the heat generating unit according to an eleventh aspect of the present invention, the heat generating element according to the first aspect has a structure having an elastic force that absorbs a thermal contraction and a thermal expansion in the heat generating element itself, the internal lead wire portion supplying the retainer with the electric power lacking an elastic structure. The heat generating unit according to the eleventh aspect of the present invention structured in this manner allows the heat generating element to surely be disposed at a desired position inside the container with a simplified structure, thereby implementing a heat source possessing great reliability and high efficiency.

In the heat generating unit according to a twelfth aspect of the present invention, the heat generating element according to the first aspect has an interlayer structure formed of the material including the carbon-based substance. The heat generating unit according to the twelfth aspect of the present invention structured in this manner is capable of heating to high temperatures, thereby implementing a heat source possessing great safety and reliability, together with high efficiency.

In the heat generating unit according to a thirteenth aspect of the present invention, the container according to the first aspect is formed with one of a heat resistant glass tube and a heat resistant ceramic tube, being filled with an inert gas and sealed at the power supply portions. The heat generating unit according to the thirteenth aspect of the present invention structured in this manner is capable of heating a heating target object uniformly and to high temperatures, thereby implementing a heat source possessing great safety and reliability.

A heating apparatus according to a fourteenth aspect of the present invention has installed therein the heat generating unit according to the first to thirteenth aspects of the present invention. Therefore, it achieves a structure possessing great safety and reliability, which can be manufactured with ease.

An image fixing device according to a fifteenth aspect of the present invention includes:

a heating element that heats a recording target member carrying an unfixed toner image; and

a pressurizing element that is arranged so as to oppose to the heating element, and that pressurizes against the heating element with the recording target member interposed, wherein

the heating element has a heat generating element as a heat source, the heat generating element being formed to be a band-like film sheet of a material including a carbon-based substance, and the heat generating element having a two-dimensional isotropic thermal conduction. The image fixing device according to the fifteenth aspect of the present invention structured in this manner starts up quick, and is capable of reducing the energy consumption.

In the image fixing device according to a sixteenth aspect of the present invention, the heat generating element according to the fifteenth aspect has an interlayer structure formed of the material including the carbon-based substance. The image fixing device according to the sixteenth aspect of the present invention structured in this manner starts up quickly, being capable of heating a recording target member highly efficiently with a desired heat distribution, and making it possible to carry out highly reliable image fixing.

In the image fixing device according to a seventeenth aspect of the present invention, the heat generating element according to the sixteenth aspect has a resistance change rate value falling within a range of 1.2 to 3.5, the resistance change rate value being obtained by dividing a resistance value in a state where lighting equilibrium is reached by energization by a resistance value in a state without energization, the heat generating element having a positive temperature coefficient characteristic in which a heat generating element temperature and a resistance value are proportional to each other. The image fixing device according to the seventeenth aspect of the present invention structured in this manner starts up quickly, being capable of heating a recording target member highly efficiently with great accuracy, with a desired heat distribution.

In the image fixing device according to an eighteenth aspect of the present invention, the heat generating element according to the seventeenth aspect may be a thin membrane element having a thickness of equal to or smaller than 300 μm. The image fixing device according to the eighteenth aspect of the present invention structured in this manner can carry out fixing with reduced energy consumption, by use of the heat source being smaller in heat capacity and starting up quickly.

In the image fixing device according to a nineteenth aspect of the present invention, the heat generating element according to the seventeenth aspect may be a lightweight membrane element having a density of equal to or smaller than 1.0 g/cm³. The image fixing device according to the nineteenth aspect of the present invention structured in this manner can carry out fixing with reduced energy consumption, by use of the heat source being smaller in heat capacity and starting up quickly.

In the image fixing device according to a twentieth aspect of the present invention, the heat generating element according to the seventeenth aspect may be formed of a material having a thermal conductivity of equal to or greater than 200 W/m·K. The image fixing device according to the twentieth aspect of the present invention structured in this manner is capable of heating with uniform heat distribution, owing to the excellent thermal conductivity of the heat generating element.

In the image fixing device according to a twenty-first aspect of the present invention, the heating element according to the seventeenth aspect may include a container that accommodates the heat generating element and part of a power supply portion supplying electric power to opposing both ends of the heat generating element, the container being structured to have its inside filled with an inert gas and to be sealed at the power supply portion. The image fixing device according to the twenty-first aspect of the present invention structured in this manner implements an image fixing device having a highly reliable heat source, thereby becoming possible to heat highly efficiently at high temperatures with a desired heat distribution.

In the image fixing device according to a twenty-second aspect of the present invention, the heating element according to the seventeenth aspect is provided with a reflection portion for defining a heating region to be heated by the heat generating element. The image fixing device according to the twenty-second aspect of the present invention structured in this manner is capable of heating the heating region highly efficiently at high temperatures with a desired heat distribution, achieving highly reliable fixing process.

In the image fixing device according to a twenty-third aspect of the present invention, the heating element according to the seventeenth aspect may be provided with the heat generating element in a plurality of numbers, respective center axes in the longitudinal direction of the plurality of heat generating elements being arranged on a straight line so as to be perpendicular to a conveying direction of the recording target member. The image fixing device according to the twenty-third aspect of the present invention structured in this manner is capable of switching the heating region depending on the recording target member, whereby it becomes possible to specify highly efficient heating at high temperatures to a desired region.

In the image fixing device according to a twenty-fourth aspect of the present invention, in the heating element according to the seventeenth aspect, a membrane element may be formed with a member that absorbs infrared radiation at a face facing the heat generating element. With the image fixing device according to the twenty-fourth aspect of the present invention structured in this manner, the heating element absorbs the heat from the heat generating element highly efficiently, whereby it becomes possible to heat the recording target member at high temperatures highly efficiently.

In the image fixing device according to a twenty-fifth aspect of the present invention, a heated range heated by the heat generating element according to the seventeenth aspect may include a nip portion being a pressed site of the recording target member pressed by the heating element and the pressurizing element, and a site located upstream relative to the nip portion in a conveying direction of the recording target member. The image fixing device according to the twenty-fifth aspect of the present invention structured in this manner is capable of carrying out the image fixing process highly efficiently and surely.

An image forming device according to a twenty-sixth aspect of the present invention includes the image fixing device according to any one of the fifteenth to twenty-fifth aspects. The image forming device according to the twenty-sixth aspect of the present invention structured in this manner can heat the recording target member being a heating target object at high temperatures with a desired heat distribution. Further, the device starts up quickly, and is capable of exerting heating control with great accuracy while reducing the energy loss.

### ADVANTAGEOUS EFFECTS OF INVENTION

According to the present invention, a heat generating unit implementing a heat source possessing great safety and reliability, together with high efficiency can be structured. Further, the present invention can provide a heat generating unit that is highly work-efficient, that is excellent in productivity, and that can easily be manufactured. Still further, according to the present invention, because the heat generating unit having the effects stated above is installed in a heating apparatus as a heat source, it becomes possible to provide a heating apparatus possessing great safety and reliability, together with high efficiency. Still further, according to the present invention, it becomes possible to provide a heating apparatus that has the high-efficient heat source that can heat a recording target member being a heating target object with a desired heat generation, and to high temperatures. In particular, with the present invention, it becomes possible to provide an image fixing device and an image forming device that start up quickly, and that are capable of carrying out a fixing process with reduced energy consumption.

### BRIEF DESCRIPTION OF DRAWINGS

FIG. 1 is a plan view showing the structure of a heat generating unit according to a first embodiment of the present invention.

FIG. 2 is a front view of the heat generating unit shown in FIG. 1.

FIG. 3 is a plan view showing a retainer 3 and the like attached to the end portion of the heat generating element in the heat generating unit according to the first embodiment.

FIG. 4 is a front view of the retainer and the like in the heat generating unit according to the first embodiment.

FIG. 5 is a plan view showing a state where a retainer of Example 1 according to a second embodiment of the present invention is attached to the heat generating element.

FIG. 6 is a plan view showing a state where a retainer of Example 2 according to the second embodiment is attached to the heat generating element.

FIG. 7 is a plan view showing a state where a retainer of Example 3 according to the second embodiment is attached to the heat generating element.

FIG. 8 is a plan view showing a state where a retainer of Example 4 according to the second embodiment is attached to the heat generating element.

FIG. 9 is a plan view showing a state where a retainer of Example 5 according to the second embodiment is attached to the heat generating element.

FIG. 10 is a plan view showing a state where a retainer of Example 6 according to the second embodiment is attached to the heat generating element.

FIG. 11 is a plan view showing the structure of a heat generating unit according to a third embodiment of the present invention.

FIG. 12 is a plan view showing the structure of a heat generating unit according to a fourth embodiment of the present invention.

FIG. 13 is a front view of the heat generating unit shown in FIG. 12.

FIG. 14 is a perspective view showing an exemplary heating apparatus according to a fifth embodiment of the present invention.

FIG. 15 shows the substantial structure of an image fixing device according to a sixth embodiment of the present invention.

FIG. 16 is a temperature characteristic diagram showing the relationship between temperature [° C.] and resistance [Ω] in a heat generating element in a heat generating unit according to the sixth embodiment.

FIG. 17 is a graph showing the start-up characteristic of each of a heat generating unit 92 used in an image fixing device according to the present invention, and a carbon heater and a halogen heater both being conventional heaters.

FIG. 18 shows a comparison among various types of heaters as to an inrush current, where (a) is a current waveform at start-up of a heat generating unit used in an image fixing device according to the sixth embodiment of the present invention; (b) is a current waveform at start-up of a conventional carbon heater; and (c) is a current waveform at start-up of a halogen heater.

FIG. 19 is a graph showing a measurement result of a copper plate temperature obtained by heating a heating target object by a heat generating unit used in the image fixing device according to the sixth embodiment of the present invention and by the conventional heaters.

### DESCRIPTION OF EMBODIMENTS

In the following, a description will be given of preferred embodiments of a heat generating unit according to the present invention and a heating apparatus using the heat generating unit with reference to the accompanying drawings.

### First Embodiment

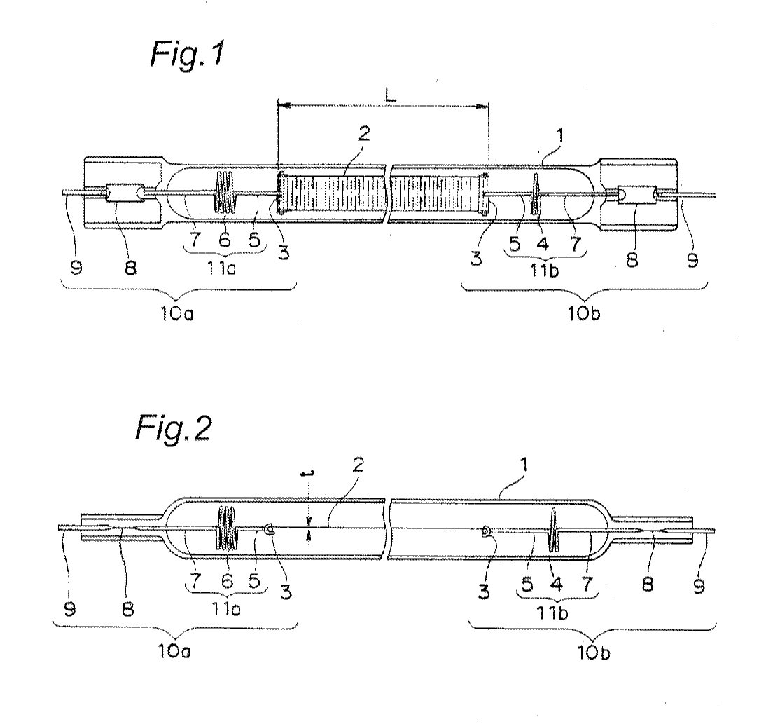

Referring to FIGS. 1 to 4, a description will be given of a heat generating unit according to a first embodiment of the present invention. FIG. 1 is a plan view showing the structure of the heat generating unit according to the first embodiment. Because the heat generating unit has an elongated shape, its intermediate portion is cutaway and omitted in FIG. 1, and both end portions thereof are shown therein. FIG. 2 is a front view of the heat generating unit shown in FIG. 1.

In the heat generating unit according to the first embodiment, a film sheet-like and band-like heat generating element 2 is disposed inside a heat resistant elongated container 1. The band-like heat generating element 2 is disposed to extend in the longitudinal direction of the container 1. In the heat generating unit according to the first embodiment, the container 1 is formed with a transparent quartz glass tube. Both the end portions of the quartz glass tube are each welded to be a flat plate shape, to thereby structure the container 1. The container accommodating the heat generating element 2 is filled with argon gas as an inert gas. The inert gas with which the container can be filled with is not limited to the argon gas. Other than the argon gas, use of a gas such as the nitrogen gas, or mixture of gases such as the argon gas and the nitrogen gas, the argon gas and a xenon gas, the argon gas and a krypton gas can achieve the effect similar to that achieved by the present invention. Accordingly, the inert gas with which the container 1 should be filled can be selected as appropriate in accordance with the intended purpose. The container 1 is filled with the inert gas for the purpose of preventing oxidation of the heat generating element 2 being a carbon-based substance in the container, when used under high temperatures. It is to be noted that any heat-resistant, insulating, and heat-transmissive material can be used as the material of the container 1. For example, in addition to the quartz glass, the material can be selected as appropriate out of glass materials such as soda lime glass, borosilicate glass, lead glass and the like, or ceramic materials or the like.

As shown in FIGS. 1 and 2, the heat generating unit according to the first embodiment includes the container 1, the elongated band-like heat generating element 2 as a heat radiation membrane element, and first and second power supply portions 10a and 10b respectively provided at both end portions in the longitudinal direction of the heat generating element 2 for holding the heat generating element 2 at a prescribed position inside the container, and for supplying the heat generating element 2 with power.

The first and second power supply portions 10a and 10b respectively provided at both the ends of the heat generating element 2 respectively include retainers 3 respectively attached to both the ends of the heat generating element 2. As to these retainers 3, a first internal lead wire portion 11a is attached to one of the retainers 3 (the left-side retainer 3 in FIG. 1), and a second internal lead wire portion 11b is attached to the other one of the retainers 3 (the right-side retainer 3 in FIG. 1). The first internal lead wire portion 11a and the second internal lead wire portion 11b are electrically connected to external lead wires 9 that are led out to the outside of the container from both the ends of the container 1 through the molybdenum foils 8 embedded in the sealed portions (welded portions) of both the end portions of the container 1, respectively.

As shown in FIGS. 1 and 2, the first power supply portion 10a is structured to include the retainer 3, the molybdenum foil 8, the external lead wire 9, and the first internal lead wire portion 11a. On the other hand, the second power supply portion 10b is structured to include the retainer 3, the molybdenum foil 8, the external lead wire 9, and the second internal lead wire portion 11b.

The first internal lead wire portion 11a is structured with a fixed portion 5 joined to the retainer 3 attached to one end (the left end in FIG. 1) of the heat generating element 2, a spring portion 6 formed in a coil-like manner and being elastic in the longitudinal direction, and an internal lead wire 7 joined to the molybdenum foil 8. The fixed portion 5, the spring portion 6, and the internal lead wire 7 are integrally formed with a single wire material, e.g., a molybdenum wire.

The second internal lead wire portion 11b is structured with a fixed portion 5, joined to the retainer 3 attached to the other end (the right end in FIG. 1) of the heat generating element 2, a position regulating portion 4 for holding the heat generating element 2 at a prescribed position in the container, and an internal lead wire 7 connected to the molybdenum foil 8. The fixed portion 5, the position regulating portion 4, and the internal lead wire 7 are integrally formed with a single wire material, e.g., a molybdenum wire. While the description is given taking up the exemplary case where the first internal lead wire portion 11a and the second internal lead wire portion 11b according to the first embodiment are each formed with the molybdenum wire, they may each be formed using an elastic metal wire of a material such as tungsten, nickel, stainless steel or the like (of a round bar shape or of a flat plate shape).

As described in the foregoing, in the heat generating unit according to the first embodiment, the first power supply portion 10a structured with the retainer 3, the molybdenum foil 8, the external lead wire 9 and the first internal lead wire portion 11a, and the second power supply portion 10b structured with the retainer 3, the molybdenum foil 8, the external lead wire 9 and the second internal lead wire portion 11b tensely arrange the heat generating element 2 inside the container.

It is to be noted that the spring portion 6 of the first internal lead wire portion 11a functions to provide a tensile force to the heat generating element 2, such that the heat generating element 2 is constantly disposed in a straight manner at a desired position in the container. In the heat generating unit according to the first embodiment, the spring portion 6 also has a function as a position regulating member for disposing the heat generating element 2 at a prescribed position in the container. The external circumference portion of the spring portion 6 is at a position close to the internal circumference face of the container 1. Disposition of the spring portion 6 allows the heat generating element 2 to surely be disposed at a position where contact between the heat generating element 2 and the container 1 is avoided. In the heat generating unit according to the first embodiment, the heat generating element 2 is disposed such that its longitudinal direction is arranged substantially on the center axis that extends in the longitudinal direction of the container 1, thereby avoiding contact between the heat generating element 2 and the container 1. Additionally, provision of the spring portion 6 between the internal lead wire 7 and the fixed portion 5 makes it possible to absorb the change in the heat generating element 2 caused by expansion and contraction.

In a case where the rate of expansion and contraction of the material of the heat generating element 2 itself possesses, or the rate of expansion and contraction owing to the shape of the heat generating element 2, is greater relative to the change in the heat generating element 2 caused by expansion and contraction, and where the heat generating element 2 itself is elastic, the internal lead wire portions 11a and 11b respectively positioned on both sides of the heat generating element 2 can dispense with the spring portion 6.

It is to be noted that, in connection with the heat generating unit according to the first embodiment, the description proceeds taking up the exemplary case where the heat generating element 2 is provided at its both the ends with the first internal lead wire portion 11a and the second internal lead wire portion 11b each having a different structure from each other's. However, in the heat generating unit of the present invention, the heat generating element 2 may be provided with a constituent member similar to the first internal lead wire portion 11a or the second internal lead wire portion 11b at each of its ends, so that the arrangement thereof is modified as appropriate according to the product specification of the heating apparatus with which the heat generating unit is used, and the intended use and the like. When the structure in which the first internal lead wire portion 11a having the spring portion 6 on one of the ends of the heat generating element 2 is employed, it becomes possible to regulate the position of the heat generating element 2 and to absorb the change thereof caused by the expansion and contraction. On the other hand, when the structure in which the first internal lead wire portion 11a is disposed each side of the heat generating element 2 is employed, it becomes possible to carry out the positional regulation and the change absorption at both the ends of the heat generating element 2, whereby achievement of a further effect can be expected.

In a case where the heat generating unit according to the first embodiment is installed in a heating apparatus such that the longitudinal direction of the heat generating unit corresponds to the vertical direction, if the spring portion 6 is disposed at a position higher than the heat generating element 2, the spring portion 6 may be heated in the expanded state by the temperature of the heat generating element 2, exceeding elastic limit to be incapable of absorbing the thermal expansion. Accordingly, the spring portion 6 is preferably used as being disposed at a position lower than the heat generating element 2 and as being compressed.

In connection with the heat generating unit according to the first embodiment, the description has been given taking up the exemplary case where the fixed portion 5, the spring portion 6 and the internal lead wire 7 of the first internal lead Wire portion 11a, and the fixed portion 5, the position regulating portion 4 and the internal lead wire 7 of the second internal lead wire portion 11b are integrally structured. However, it goes without saying that the identical effect can be achieved even if these components are structured as separate members, so long as they are electrically connected to one another.

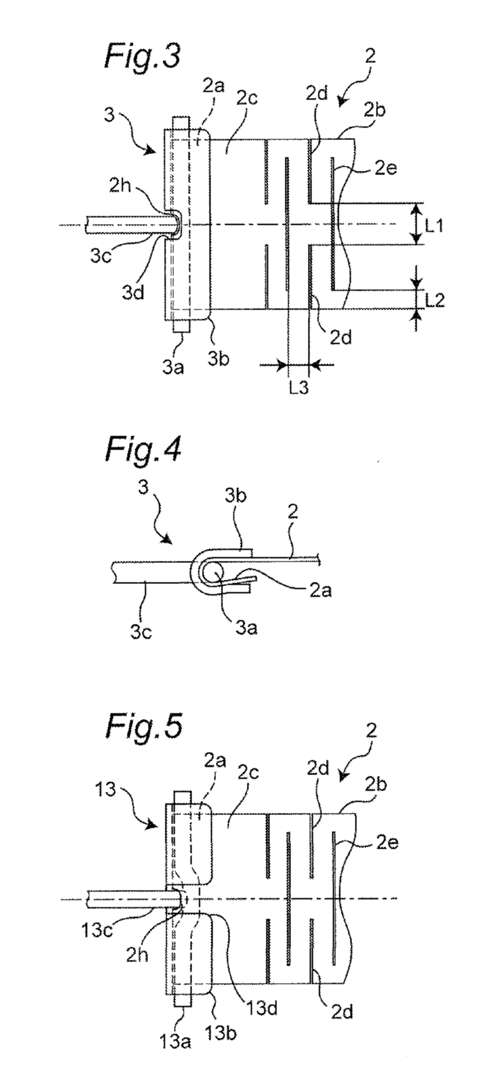

FIGS. 3 and 4 show the retainer 3 and the like attached to each of the end portions of the heat generating element 2 in the heat generating unit according to the first embodiment. FIG. 3 is a plan view of the retainer 3 and the like having the heat generating element 2 attached thereto, and FIG. 4 is a front view of the retainer 3 and the like having the heat generating element 2 attached thereto.

Each retainer 3 used in the heat generating unit according to the first embodiment is structured with a rod-like hook-received portion 3a formed with an electrically conductive and heat resistant metal material, e.g., a molybdenum wire material, a hook portion 3b to which the hook-received portion 3a is fitted, and an engagement-stop portion 3c extending from the hook-received portion 3a. As shown in FIGS. 3 and 4, around the rod-like hook-received portion 3a, a heat generating element holder portion 2a serving as an end portion of the heat generating element 2 is wrapped as being folded back. The hook portion 3b is fitted to the hook-received portion 3a having the heat generating element holder portion 2a wrapped around as being folded back, so as to clamp the heat generating element holder portion 2a of the heat generating element 2. The hook portion 3b is formed with an elastic member, and structured so as to tightly grasp the hook-received portion 3a. The cross-sectional shape of the hook portion 3b taken along the longitudinal direction of the heat generating element 2 clamped by the hook portion 3b is a C-shape, so as to be fitted to the rod-like hook-received portion 3a to tightly grasp the external surface of the hook-received portion 3a with the heat generating element holder portion 2a interposed therebetween.

Each engagement-stop portion 3c extends from the central position (the center axis position that is parallel to the longitudinal direction of the heat generating element 2) of the hook-received portion 3a of the retainer 3, so as to lead toward corresponding one of the internal lead wire portions 11a and 11b. Each engagement-stop portion 3c extending from the hook-received portion 3a is connected to the fixed portion 5 of corresponding one of the internal lead wire portions 11a and 11b. Accordingly, in the heat generating unit according to the first embodiment, what is called a T-shape form is structured by the hook-received portion 3a and the engagement-stop portion 3c.

It is to be noted that, in connection with the heat generating unit according to the first embodiment, while the description proceeds taking up the exemplary case where the engagement-stop portion 3c and the fixed portion 5 are integrally formed with a single wire material, they may be formed as separate members and joined to each other.

A through hole 2h is formed at each heat generating element holder portion 2a of the heat generating element 2 held by the retainers 3 structured as described above. When wrapping the heat generating element holder portion 2a around the hook-received portion 3a so as to fold back, a state where the engagement-stop portion 3c extending from the center of the hook-received portion 3a to the fixed portion 5 penetrates through the through hole 2h of the heat generating element holder portion 2a is established. In this state, the hook portion 3b is fitted to the hook-received portion 3a so as to clamp the heat generating element holder portion 2a. Here, the engagement-stop portion 3c penetrates through, not only the through hole 2h of the heat generating element holder portion 2a, but also a through hole 3d formed at the central position (the center axis position that is parallel to the longitudinal direction of the heat generating element 2) of the hook portion 3b. Accordingly, the heat generating element 2 is surely held without coming off from the retainers 3.

As described above, in the heat generating unit according to the first embodiment of the present invention, into the through hole 2h of each heat generating element holder portion 2a serving as the end portion of the heat generating element 2, the engagement-stop portion 3c of the retainer 3 is inserted; the heat generating element holder portion 2a is wrapped around the hook-received portion 3a; and the hook portion 3b is fitted to the hook-received portion 3a, whereby the heat generating element holder portion 2a is surely held. Thus, to the retainers 3 that hold the heat generating element holder portions 2a, a tensile force is applied by the first internal lead wire portion 11a and the second internal lead wire portion 11b, whereby the heat generating element 2 is tensely arranged in a straight manner at a prescribed position inside the container.

In a state where the retainers 3 hold the heat generating element 2 and the heat generating element 2 is tensely arranged inside the container, the site of each hook-received portion 3a around which corresponding one of the heat generating element holder portions 2a is wrapped as being folded back is arranged in the width direction perpendicular to the longitudinal direction of the heat generating element 2. In other words, the axial direction of the hook-received portion 3a being a rod-like element around which the heat generating element holder portion 2a is wrapped corresponds to the direction perpendicular to the longitudinal direction of the heat generating element 2.

In the heat generating unit according to the first embodiment, in order for the retainers 3 to tensely arrange the heat generating element 2 in a straight manner at a prescribed position while avoiding contact between the heat generating element 2 and the internal surface of the container 1, both the end portions of the hook-received portion 3a are respectively disposed at positions close to the internal surface of the container 1. Accordingly, the length of the rod-like hook-received portion 3a is set to be greater than the width of the heat generating element 2 and to be smaller than the inner diameter of the container 1.

The heat generating element 2 used in the heat generating unit according to the first embodiment of the present invention is formed with a film sheet-like material that includes a carbon-based substance as its main component, that has a layered structure in which the layers are partially bonded to one another in the thickness direction such that a space is formed between each of the layers, that exhibits an excellent two-dimensional isotropic thermal conduction, and that has a thermal conductivity of equal to or greater than 200 W/m·K. Accordingly, the band-like heat generating element 2 implements a heat source being free of temperature variations and providing uniform heat generation.

The film sheet raw material, which is the material of the heat generating element 2, is a heat resistant high orientation graphite film sheet obtained by carrying out heat treatment to a high polymer film or a high polymer film with added filler at high temperatures, e.g., in an atmosphere equal to or higher than 2400° C., and firing the same to graphitize, and the material possesses such a characteristic that the thermal conductivity in the planar direction is equal to or greater than 200 W/m·K, ranging from 600 to 950 W/m·K. Thus, the heat generating element 2 used in the first embodiment exhibits the excellent two-dimensional isotropic thermal conduction in which the thermal conductivity in the planar direction ranges from 600 to 950 W/m·K.

As used herein, the two-dimensional isotropic thermal conduction means that the thermal conductivity in every direction on a plane determined by X axis and Y axis perpendicular to each other is substantially the same. Accordingly, in the present invention, the two-dimensional isotropy not only refers to one direction (X axis direction), which is, e.g., the carbon fiber direction in a heat generating element formed by carbon fibers being juxtaposed in the same direction, or two directions (the X axis direction and the Y axis direction), which are the carbon fiber directions in a heat generating element formed by a material woven in a crossing manner of carbon fibers, but it refers to the fact that the film sheet-like heat generating element 2 exhibits an identical property in the planar direction.

A film sheet raw material serving as a material of a heat generating element 2 employed in the present invention has a layered structure. The layer surfaces in the planar direction are in various planar shapes, such as flat surfaces, uneven surfaces or wavy surfaces. A space is formed between any opposing layers. In the layered structure of the film sheet raw material, the image of layers having spaces formed in between can be similar to a cross section of a pie, which is obtained by preparing a pie dough so as to carry out folding works to place half of the dough on top of the other half for a plurality of (for example, some tens or hundreds of) times, and baking such a pie dough. In other words, the heat generating element 2 is a film sheet raw material pliable in the thickness direction, which has an interlayer structure in which a plurality of membrane elements formed with a material including carbon-based substance are layered, the membrane elements being partially bonded to one another in the layered direction. Accordingly, the film sheet raw material serving as the material of the heat generating element 2 according to the present invention is a material that exhibits the excellent two-dimensional isotropic thermal conduction whose thermal conductivity in the planar direction is substantially identical as described above, and, as shown in FIG. 4, that has pliability that allows the heat generating element 2 to be wrapped along the external surface of the hook-received portion 3a.

The high polymer film used as the film sheet raw material manufactured in the manner described in the foregoing may include at least one kind of high polymer film selected from the group consisting of polyoxadiazole, polybenzothiazole, polybenzobisthiazole, polybenzoxazole, polybenzobisoxazole, polypyromellitic imide (pyromellitic imide), polyphenylene isophthalic amide (phenylene isophthalic amide), polyphenylene benzimidazole (phenylene benzimidazole), polyphenylene benzobisimidazole (phenylene benzobisimidazole), polythiazole and polyparaphenylenevinylene. Further, the filler to be added to the high polymer film may include: phosphoric acid ester-based, calcium phosphate-based, polester-based, epoxy-based, stearic acid-based, trimellitic acid-based, metal oxide-based, organic tin-based, lead-based, azo-based, nitroso-based and sulfonyl hydrazide-based compounds. More specifically, examples of phosphoric acid ester-based compounds may include: tricresyl phosphate, (trisisopropylphenyl) phosphate, tributyl phosphate, triethyl phosphate, trisdichloropropyl phosphate and trisbutoxyethyl phosphate. Examples of calcium phosphate-based compounds may include: calcium dihydrogen phosphate, calcium hydrogen phosphorous and calcium triphosphate. Examples of polyester-based compounds may include: a polymer obtained by a reaction between adipic acid, azelaic acid, sebacic acid, phthalic acid or the like, and glycol, glycerins or the like. Further, examples of stearic acid-based compounds may include: dioctyl sebacate, dibutyl sebacate, and acetyltributyl citrate. Examples of metal oxide-based compounds may include: calcium oxide, magnesium oxide and lead oxide. Examples of trimellitic acid-based compounds may include: dibutyl fumarate and diethyl phthalate. Examples of lead-based compounds may include: lead stearate and lead silicate. Examples of azo-based compounds may include: azodicarboxylic amide and azobisisobutylonitrile. Examples of nitroso-based compounds may include: nitrosopentamethylene tetramine. Examples of sulfonyl hydrazide-based compounds may include: p-toluenesulfonyl hydrazide.

By stacking the above-described film sheet raw materials, treating the same in an inert gas at a temperature equal to or greater than 2400° C., and exerting control by adjusting the pressure of the gas treatment atmosphere produced during a process of graphitization, the film sheet-like heat generating element is manufactured. Further, by rolling the film sheet-like heat generating element manufactured in the manner described in the foregoing as necessary, the film sheet-like heat generating element of a further excellent quality can be obtained. The film sheet-like heat generating element manufactured in this manner is used as the heat generating element 2 in the heat generating unit of the present invention.

The appropriate adding amount of the filler falls within a range of 0.2 to 20.0% by weight, and more preferably, within a range of 1.0 to 10.0% by weight. The optimum adding amount differs depending on the thickness of the high polymer. The greater amount of the adding amount is preferable when the high polymer is the thinner, and the smaller amount of adding amount will suffice when the high polymer is thicker. The filler plays a role of establishing a uniformly foamed state of the film having undergone the heat treatment. In other words, the added filler generates gas during heating, which leaves cavities serving as passages that aid in smooth release of the decomposition gas from inside the film. In this manner, the filler is helpful for creating the uniformly foamed state.

The film sheet raw material manufactured in the manner described in the foregoing is processed into a desired shape by use of, for example, a trimming die, i.e., Thomson die or Pinnacle die, a sharp-edged tool such as a rotary die cutter and the like, or by use of laser processing or the like.

The heat generating element 2 according to the first embodiment has a thickness (t) of 100 μm and a width (W) of 6.0 mm, and a heat generating portion 2b has a length (L) of 300 mm. It is to be noted that the length, the width and the thickness of the heat generating element 2 are determined by an input voltage, a heat generating temperature and the like, and can be modified as appropriate according to the product specification implementing the heat source with which the heat generating unit is used, and the intended use.

It is to be noted that, as the heat generating element 2 according to the first embodiment, a thin membrane element equal to or smaller than 300 μm is used.

As shown in FIG. 3, in the heat generating portion 2b serving as the part that generates heat in the heat generating element 2 according to the first embodiment, a groove pattern is formed, wherein a plurality of grooves extend in the direction perpendicular to the longitudinal direction of the heat generating element 2. The plurality of grooves formed in the heat generating portion 2b function to regulate the direction of the current flow in the heat generating portion 2b, and to adjust the resistance value. The shape of each groove formed in the heat generating portion 2b includes a perforated groove (slit), a bottomed groove (recess groove) and the like, according to the specification of the product with which the heat generating unit is used, and the intended use and the like. Further, by varying the depth in the thickness direction of the recess groove, the resistance value of the heat generating portion 2b can be adjusted.

In the heat generating portion 2b of the heat generating element 2 according to the first embodiment, a groove pattern, e.g., the one shown in FIG. 3, is repeatedly formed. That is, in the heat generating portion 2b of the heat generating element 2, the following are alternately formed in the longitudinal direction: a pair of edge grooves 2d that extend from opposing positions on the respective edge portions being parallel to the longitudinal direction of the heat generating portion 2b toward the center side while being perpendicular to the longitudinal direction of the heat generating portion 2b; and a center groove 2e that is formed at the central portion of the central portion of the heat generating portion 2b while being perpendicular to the longitudinal direction of the heat generating portion 2b. As to the pair of opposing edge grooves 2d and 2d in the heat generating portion 2b, their respective end portions on the center side so as to oppose to each other keep a first prescribed distance (the distance indicated by L1 in FIG. 3) between them, so as to form an energization path at the central portion of the heat generating portion 2b. The edge-side end portions serving as both end portions of the center groove 2e each keep an identical second prescribed distance (the distance indicated by L2 in FIG. 3) from corresponding edge portion of the heat generating portion 2b in the width direction, so as to form an energization path near the corresponding one of both-side edge portions of the heat generating portions 2b. Further, in the heat generating portion 2b of the heat generating element 2, an interval between each edge groove 2d and each center groove 2e in the longitudinal direction has a third prescribed distance (the distance indicated by L3 in FIG. 3), so as to form a current path between the edge grooves 2d and the center grooves 2e, which flows in the direction perpendicular to the longitudinal direction of the heat generating element 2.

In the heat generating element 2 according to the first embodiment, the third prescribed distance L3 being the interval in the longitudinal direction between each edge groove 2d and each center groove 2e is set to be as great as the second prescribed distance L2, and the first prescribed distance L1 is set to be twice as great as the second prescribed distance L2 and as the third prescribed distance L3. In the heat generating portion 2b of the heat generating element 2 where such a groove pattern is formed, a meandering current path is formed, in which the cross-sectional area perpendicular to the same current is substantially constant. This facilitates calculation of the resistance value, and achieves setting of a uniform temperature distribution. It is to be noted that, with a material having such a characteristic that the thermal conductivity in the planar direction of the heat generating element 2 is, e.g., equal to or greater than 600 W/m·K, the uniform temperature distribution (heat distribution) will not greatly be affected even if the second prescribed distance L2 is not half as great as the first prescribed distance L1. Preferably, by setting the second prescribed distance L2 to be equal to or greater than half the first prescribed distance L1, the mechanical strength of the heat generating element 2 against any shock applied to the heat generating unit can be enhanced.

Further, by appropriately selecting the groove-shaped slits or the recess grooves formed in the heat generating portion 2b according to the specification of the product with which the heat generating unit is used, or the intended use, it becomes possible to obtain the temperature distribution (heat distribution pattern) of the heat generating portion 2b of a desired pattern.

Still further, in the heat generating portion 2b, by designing the interval L3 in the longitudinal direction between each edge groove 2d and each center groove 2e to become gradually wider as reaching nearer to the end portions in the longitudinal direction of the heat generating element 2, i.e., as reaching nearer to the heat generating element holder portions 2a, it becomes possible to gradually change the resistivity of the current path in the heat generating portion 2b, so as to change the temperature distribution (heat distribution pattern) of the heat generating portion 2b such that the central portion attains high temperatures. Naturally, by changing the intervals L1, L2, and L3 according to the specification of the product with which the heat generating unit is used, or the intended use as appropriate, it becomes possible to implement the heat source having a desired heat distribution pattern.

In the heat generating element 2 according to the first embodiment, heat dissipation regions 2c each leading from the heat generating element holder portion 2a to the heat generating portion 2b have the heat dissipation function. The heat dissipation region 2c having this heat dissipation function is provided with none of the grooves such as described in the foregoing, and a wide current path is formed. Consequently, in the heat dissipation region 2c, the heat transferred from the heat generating portion 2b is dissipated, whereby a reduction in thermal stress and an increase in service life are achieved as to the heat generating element 2.

Further, in the heat generating element 2 according to the first embodiment, the heat generating element holder portion 2a and the heat generating portion 2b are formed to have an identical width. However, it is also possible to form the heat generating element holder portion 2a to be smaller in width than the heat generating portion 2b. In such a case, the edge shape of the heat dissipation region 2c leading from the heat generating element holder portion 2a to the heat generating portion 2b is preferably formed as a curved surface shape in order to avoid any damage caused by a concentrated load.

When the temperature of the heat generating portion 2b is high because of the product specification, by gradually narrowing the width in the heat dissipation region 2c from the heat generating portion 2b toward the heat generating element holder portion 2a, it becomes possible to provide the temperature gradient to the heat dissipation region 2c, so as to reduce the thermal stress of the heat generating element holder portion 2a.

Further, in the heat generating element 2, by designing the length of the first prescribed distance L1 and that of the second prescribed distance L2 to become gradually greater as reaching nearer to the heat generating element holder portion 2a on each side, it becomes possible to provide the temperature gradient to the heat generating portion 2b, and to obtain a structure with a great mechanical strength exhibiting the great shock resistance and the vibration resistance.

In the heat generating element 2 structured as described above, because the groove pattern having a plurality of grooves inhibiting the current flow is formed in the heat generating portion 2b, a desired current path can be set without being restricted by the overall shape of the heat generating portion 2b. As a result, with the heat generating unit according to the first embodiment, it is possible to set a desired heat generation distribution according to the product specification, the intended use or the like. Therefore, it can be used as a versatile heat source.

It is to be noted that, the heat generating element 2 in the heat generating unit according to the first embodiment is shaped band-like by press working, and processed so as to be provided with grooves. However, it is also possible to use a laser to process the same to have a desired shape. For example, as an exemplary case of performing laser processing, when the thermal conductivity in the planar direction of the heat generating element 2 is equal to or greater than 200 W/m·K, there arises a problem that the intended processing cannot be carried out using laser processing which mainly exerts the thermal processing effect, such as a CO₂ laser (wavelength 10600 nm), because the heat generating element 2 deprives the laser of heat. However, by use of laser processing of the wavelengths 1064 to 380 nm which mainly exerts the nonthermal processing effect, for example by use of short wavelength laser processing of a nominal wavelength 1064 nm, a desired shape can be formed with great accuracy.

In particular, the inventors have demonstrated that use of the second harmonic laser processing of a nominal wavelength 532 nm in forming the heat generating element 2 according to the first embodiment achieves processing with great accuracy. The material of the heat generating element 2 according to the first embodiment is a film sheet raw material, i.e., a heat resistant high orientation graphite film sheet obtained by carrying out heat treatment to a high polymer film or a high polymer film with added filler at high temperatures, e.g., in an atmosphere of equal to or higher than 2400° C., and firing the same to graphitize. The heat generating element 2 is formed with a material having such a characteristic that the thermal conductivity in the planar direction is from 600 to 950 W/m·K. When forming the heat generating element 2 using such a material, so as to have a thickness (t) of 100 μm, a width (W) of 6.0 mm, and a length (L) of 300 mm, for example, or when providing the heat generating portion 2b with a complicated shape such as the grooves (slits) as described above, it is desirable to employ the second harmonic laser processing of a nominal wavelength 532 nm.

It goes without saying that a preferable laser processing method can be selected as appropriate in accordance with the material of the heat generating element 2, that is, in accordance with the thermal conductivity in the planar direction and the shape thereof, out of the aforementioned processing methods with laser processing wavelength (1064 to 380 nm) with which the nonthermal processing effect is mainly exerted. Furthermore, it goes without saying that the laser processing method for processing the above-described heat generating element 2 can be employed in processing any heat generating element of a heat generating unit according to other embodiments which will be described later.

As described in the foregoing, in the heat generating unit according to the first embodiment, both the end portions of the band-like heat generating element 2 are surely held by the retainers 3 of a simple structure, and an electrically connected state is maintained while the heat generating element 2 is at a prescribed position inside the container. In this manner, because the heat generating element 2 is surely held at a prescribed position inside the container by the retainers 3, the heat generating unit according to the first embodiment can structure a heat source exhibiting great safety and reliability, while being highly efficient. Further, because the heat generating unit according to the first embodiment is simply structured, it becomes possible to provide a heat generating unit that is highly work-efficient and that is excellent in productivity.

### Second Embodiment

In the following, a description will be given of a heat generating unit according to a second embodiment of the present invention with reference to FIGS. 5 to 10. The heat generating unit according to the second embodiment is different from the heat generating unit according to the first embodiment in the structure and in the shape of the retainers respectively attached to both ends of the heat generating element 2.

In connection with the heat generating unit according to the second embodiment, a description will be given of each of six types of specific examples regarding the retainers being different from one another in the structure and in the shape. In the examples of the second embodiment, their respective structures are the same as that of the heat generating unit according to the first embodiment, except for the retainers in the heat generating units. Accordingly, in connection with the heat generating unit in the examples of the second embodiment, the constituents having the same function and structure as those of the heat generating unit according to the first embodiment are denoted by the same reference characters, and the description given in the first embodiment is applied thereto.

### Example 1

In the following, a description will be given of the structure of each retainer 13 of Example 1 in the heat generating unit according to the second embodiment with reference to FIG. 5. FIG. 5 is a plan view showing a state where the retainer 13 of Example 1 holds the heat generating element 2 in the heat generating unit according to the second embodiment.

As shown in FIG. 5, each retainer 13 is structured with a rod-like hook-received portion 13a formed with an electrically conductive metal material, e.g., a molybdenum wire material, a hook portion 13b fitted to the hook-received portion 13a, and an engagement-stop portion 13c extending from the hook-received portion 13a. Similarly to the first embodiment, around the rod-like hook-received portion 13a, a heat generating element holder portion 2a serving as an end portion of the heat generating element 2 is wrapped as being folded back. Also similarly to the first embodiment, the through hole 2h is formed at each heat generating element holder portion 2a, into which the engagement-stop portion 13c extending from the center of the hook-received portion 13a and leading to the fixed portion 5 is inserted.

To the hook-received portion 13a around which the heat generating element holder portion 2a is wrapped, the hook portion 13b is fitted so as to clamp the heat generating element holder portion 2a of the heat generating element 2. The hook portion 13b is formed with an elastic member, and structured so as to tightly grasp the hook-received portion 13a. The cross-sectional shape of the hook portion 13b taken along the longitudinal direction of the heat generating element 2 clamped by the hook portion 13b is a C-shape, so as to be fitted to the rod-like hook-received portion 13a to tightly grasp the external surface of the hook-received portion 13a with the heat generating element holder portion 2a interposed therebetween.

As shown in FIG. 5, at the hook portion 13b, a cut 13d being parallel to the longitudinal direction of the heat generating element 2 is formed. In the cut 13d, the engagement-stop portion 13c extended from the center of the hook-received portion 13a toward the fixed portion 5 is arranged. As to each retainer 13 of Example 1, the hook portion 13b is formed with a molybdenum plate having a thickness of, e.g., 0.2 mm.

It is to be noted that, the material of the hook portion 13b is not limited to the aforementioned molybdenum, and any heat resistant material such as tungsten, nickel, stainless steel may be used.

As shown in FIG. 5, the central portion of the hook-received portion 13a is bent to form a recess. At the center of the recess (the center axis position parallel to the longitudinal direction of the heat generating element 2), the engagement-stop portion 13c leading to corresponding one of respective fixed portions 5 of the internal lead wire portions 11a and 11b is joined (for example, by spot welding). It is to be noted that, while the description proceeds in Example 1 taking up the exemplary case where the engagement-stop portion 13c and the fixed portion 5 are formed with a single wire material, they may be formed as separate members and joined to each other to structure the retainer 13.

As described above, the through hole 2h is formed at each heat generating element holder portion 2a held by corresponding one of the retainers 13, the engagement-stop portion 13c is inserted into the through hole 2h. In a state where the heat generating element holder portion 2a is wrapped around the hook-received portion 13a, the hook portion 13b is fitted to the hook-received portion 13a. Here, in the cut 13d of the hook portion 13b, an engagement-stop portion 13c protruding from the center of the hook-received portion 13a is disposed. Thus, the heat generating element 2 enters a surely held state without coming off from the retainers 13.

In a state where the retainers 13 hold the heat generating element 2 and the heat generating element 2 is tensely arranged inside the container, the site of each hook-received portion 13a around which corresponding one of the heat generating element holder portions 2a is wrapped as being folded back is arranged in the width direction perpendicular to the longitudinal direction of the heat generating element 2. In other words, the axial direction of the hook-received portion 13a being a rod-like element around which the heat generating element holder portion 2a is wrapped corresponds to the direction perpendicular to the longitudinal direction of the heat generating element 2.

As described above, into the through hole 2h of each heat generating element holder portion 2a serving as the end portion of the heat generating element 2, the engagement-stop portion 13c extending from the hook-received portion 13a is inserted and engagingly stopped. In addition thereto, the heat generating element holder portion 2a is wrapped around the hook-received portion 13a as being folded back. In this state, the hook portion 13b is fitted to the hook-received portion 13a, whereby the heat generating element holder portion 2a is clamped.

As described in the foregoing, in the heat generating unit according to the second embodiment, use of the retainers 13 of Example 1 allows both the end portions of the band-like heat generating element 2 to more surely be held by the retainers 13, whereby the heat generating element 2 can maintain the electrical and mechanical connection state at a prescribed position inside the container with great reliability.

### Example 2

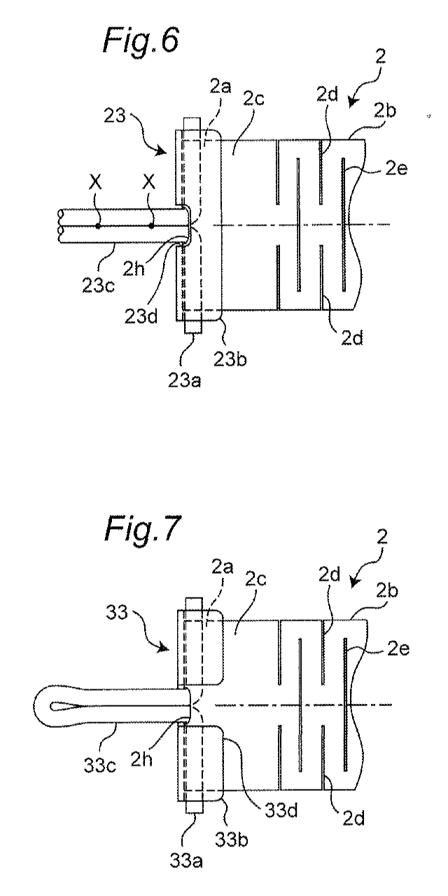

In the following, a description will be given of the structure of each retainer 23 of Example 2 of the second embodiment with reference to FIG. 6. FIG. 6 is a plan view showing a state where, in the heat generating unit according to the second embodiment, the retainer 23 of Example 2 holds the heat generating element 2.

Similarly to the retainers 13 of the Example 1, each retainer 23 of Example 2 is also structured with a hook-received portion 23a, a hook portion 23b fitted to the hook-received portion 23a, and an engagement-stop portion 23c extending from the hook-received portion 23a, respectively formed of the same material as those constituents of each retainer 13 of Example 1. As shown in FIG. 6, the hook-received portion 23a of the retainer 23 is formed by bending electrically conductive wire materials. The hook-received portion 23a and the engagement-stop portion 23c of the retainer 23 of Example 2 are structured by bending respective end portions of two rod-like wire materials about 90 degrees into an L-shape. The two rod-like wire materials have their respective tip portions arranged so as to protrude in the directions reverse to each other (180 degrees), to thereby structure the hook-received portion 23a. Accordingly, the hook-received portion 23a of the retainer 23 is made up of two wire materials arranged in a straight manner, each having a bent tip portion that is arranged so as to protrude in the directions reverse to the other's direction. To this hook-received portion 23a, the heat generating element holder portion 2a of the heat generating element 2 is wrapped around as being folded back.

The engagement-stop portion 23c of the retainer 23 is structured to be inserted into an elongated hole-shaped through hole 2h formed at the heat generating element holder portion 2a serving as the end portion of the heat generating element 2.

As shown in FIG. 6, in the engagement-stop portion 23c structured by juxtaposing the two wire materials leading from the hook-received portion 23a to the fixed portion 5, the juxtaposed wire materials are spot welded at two positions indicated by reference character X.

To the hook-received portion 23a around which the heat generating element holder portion 2a is wrapped, the hook portion 23b is fitted so as to clamp the heat generating element holder portion 2a of the heat generating element 2. The hook portion 23b is formed with an elastic member, and structured so as to tightly grasp the hook-received portion 23a. At the center of the hook portion 23b, an elongated hole-shaped through hole 23d is formed, the engagement-stop portion 23c structured with the two wire materials leading from the' hook-received portion 23a to the fixed portion 5 is previously inserted into the through hole 23d. The cross-sectional shape of the hook portion 23b taken along the longitudinal direction of the heat generating element 2 clamped by the hook portion 23b is a C-shape, so as to be fitted to the rod-like hook-received portion 23a to tightly grasp the external surface of the hook-received portion 23a with the heat generating element holder portion 2a interposed therebetween.

While the description has been given taking up the exemplary case where the through hole 23d is formed at the center of the hook portion 23b, it is possible to employ a structure in which a cut is formed instead of the through hole 23d, and the engagement-stop portion 23c leading from the hook-received portion 23a to the fixed portion 5 is arranged at the cut.

While each retainer 23 of Example 2 is structured such that the engagement-stop portion 23c structured with the two wire materials is joined to the fixed portion 5, the engagement-stop portion 23c and the fixed portion 5 may be integrally formed with the same structure.

As described above, into the through hole 2h of each heat generating element holder portion 2a serving as the end portion of the heat generating element 2, the engagement-stop portion 23c is inserted and engagingly stopped. In addition thereto, the heat generating element holder portion 2a is wrapped around the hook-received portion 23a of the retainer 23. In this state, the hook portion 23b is fitted to the hook-received portion 23a, whereby the heat generating element holder portion 2a is clamped.

As described in the foregoing, in the heat generating unit according to the second embodiment, use of the retainers 23 of Example 2 allows both the end portions of the band-like heat generating element 2 to more surely be held by the retainers 23, whereby the heat generating element 2 can maintain the electrical and mechanical connection state at a prescribed position inside the container with great reliability.

### Example 3

In the following, a description will be given of the structure of each retainer 33 of Example 3 of the second embodiment with reference to FIG. 7. FIG. 7 is a plan view showing a state where, in the heat generating unit according to the second embodiment, the retainer 33 of Example 3 holds the heat generating element 2.

Similarly to the retainers 13 of the Example 1, each retainer 33 of Example 3 is also structured with a hook-received portion 33a, a hook portion 33b fitted to the hook-received portion 33a, and an engagement-stop portion 33c extending from the hook-received portion 33a, respectively formed of the same material as those constituents of each retainer 13 of Example 1. As shown in FIG. 7, the hook-received portion 33a and the engagement-stop portion 33c of the retainer 33 are formed by bending a single electrically conductive wire material. The hook-received portion 33a of the retainer 33 of Example 3 is formed by folding a single rod-like wire material in two, and thereafter bending both the end portions approximately 90 degrees. As shown in FIG. 7, the hook-received portion 33a is structured by having its tip portions arranged so as to protrude in the directions reverse to each other (180 degrees). Accordingly, the hook-received portion 33a of the retainer 33 is structured by the single wire material having its both end portions arranged in a straight manner. To this hook-received portion 33a, the heat generating element holder portion 2a of the heat generating element 2 is wrapped around as being folded back. The engagement-stop portion 33c of the retainer 33 is structured to be inserted into an elongated hole-shaped through hole 2h formed at the heat generating element holder portion 2a serving as the end portion of the heat generating element 2.

As shown in FIG. 7, the engagement-stop portion 33c serving as the lead-out portion from the hook-received portion 33a is joined to the fixed portion 5, so as to be electrically and mechanically connected by use of, for example, swaging, welding and the like.

To the hook-received portion 33a around which the heat generating element holder portion 2a is wrapped, the hook portion 33b is fitted so as to clamp the heat generating element holder portion 2a of the heat generating element 2. The hook portion 33b is formed with an elastic member, and structured so as to tightly grasp the hook-received portion 33a. At the central portion of the hook portion 33b, a cut 33d is formed, inside which the engagement-stop portion 33c leading from the hook-received portion 33a to the fixed portion 5 is disposed when the hook portion 33b tightly grasps the hook-received portion 33a. The cross-sectional shape of the hook portion 33b taken along the longitudinal direction of the heat generating element 2 clamped by the hook portion 33b is a C-shape, so as to be fitted to the hook-received portion 33a to tightly grasp the external surface of the hook-received portion 33a with the heat generating element holder portion 2a interposed therebetween.

While the description has been given taking up the exemplary case where the cut 33d is formed at the central position (the center axis position parallel to the longitudinal direction of the heat generating element 2) of the hook portion 33b, it is possible to employ a structure in which a through hole is formed instead of the cut 33d, and the engagement-stop portion 33c is inserted into the through hole.

As described above, into the through hole 2h of each heat generating element holder portion 2a serving as the end portion of the heat generating element 2, the engagement-stop portion 33c is inserted and engagingly stopped. In addition thereto, the heat generating element holder portion 2a is wrapped around the hook-received portion 33a of the retainer 33. In this state, the hook portion 33b is fitted to the hook-received portion 33a, whereby the heat generating element holder portion 2a is clamped.

As described in the foregoing, use of the retainers 33 of Example 3 in the heat generating unit according to the second embodiment allows both the end portions of the band-like heat generating element 2 to more surely be held by the retainers 33, whereby the heat generating element 2 can maintain the electrical and mechanical connection state at a prescribed position inside the container with great reliability.

### Example 4

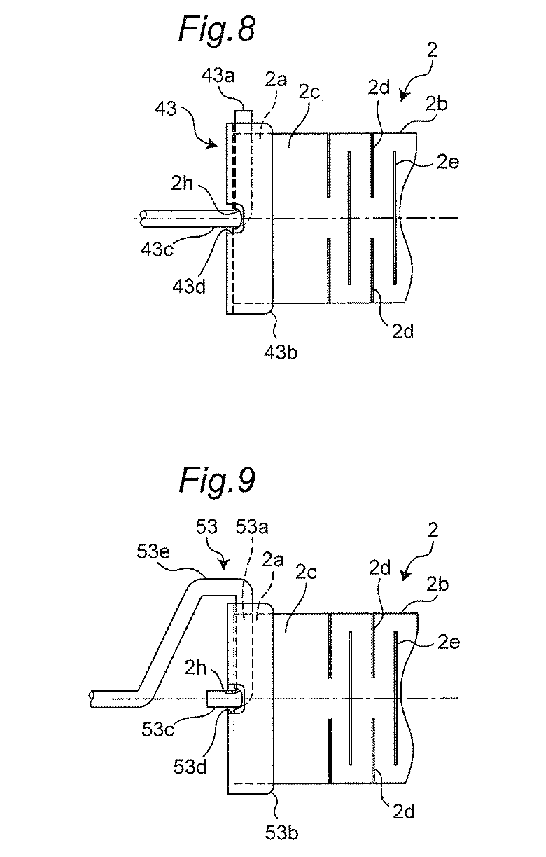

In the following, a description will be given of the structure of each retainer 43 of Example 4 of the second embodiment with reference to FIG. 8. FIG. 8 is a plan view showing a state where, in the heat generating unit according to the second embodiment, the retainer 43 of Example 4 holds the heat generating element 2.

Similarly to the retainers 13 of the Example 1, each retainer 43 of Example 4 is also structured with a hook-received portion 43a, a hook portion 43b fitted to the hook-received portion 43a, and an engagement-stop portion 43c extending from the hook-received portion 43a, respectively formed of the same material as those constituents of each retainer 13 of Example 1. As shown in FIG. 8, the hook-received portion 43a and the engagement-stop portion 43c of the retainer 43 are formed by bending an electrically conductive wire material. The hook-received portion 43a and the engagement-stop portion 43c of the retainer 43 of Example 4 are formed by bending the end portion of a single rod-like wire material approximately 90 degrees so as to form an L-shape. Accordingly, the hook-received portion 43a of the retainer 43 is structured by having its tip portion bent, the heat generating element holder portion 2a of the heat generating element 2 is wrapped around the tip portion. The engagement-stop portion 43c of the retainer 43 is structured to be inserted into the through hole 2h formed at the heat generating element holder portion 2a serving as the end portion of the heat generating element 2.

As shown in FIG. 8, to the hook-received portion 43a around which the heat generating element holder portion 2a is wrapped, the hook portion 43b is fitted so as to clamp the heat generating element holder portion 2a of the heat generating element 2. The hook portion 43b is formed with an elastic member, and structured so as to tightly grasp the hook-received portion 43a. At the central position (the center axis position parallel to the longitudinal direction of the heat generating element 2) of the hook portion 43b, a through hole 43d is formed, the engagement-stop portion 43c leading from the hook-received portion 43a to the fixed portion 5 is inserted into the through hole 43d. The cross-sectional shape of the hook portion 43b taken along the longitudinal direction of the heat generating element 2 clamped by the hook portion 43b is a C-shape, so as to be fitted to the rod-like hook-received portion 43a to tightly grasp the same with the heat generating element holder portion 2a wrapped around the external surface of the hook-received portion 43a interposed therebetween.

While the description has been given taking up the exemplary case where the through hole 43d is formed at the center of the hook portion 43b, it is also possible to employ a structure in which a cut is formed instead of the through hole 43d, and the engagement-stop portion 43c is disposed into the cut.

As to the retainer 43 of Example 4, while the description has been given of the structure in which the retainer 43 and the fixed portion 5 are integrally formed with the wire material, it is also possible to employ a structure in which the fixed portion 5 and the retainer 43 are respectively structured with separate members, and then joined to each other.

As described above, into the through hole 2h of each heat generating element holder portion 2a serving as the end portion of the heat generating element 2, the engagement-stop portion 43c is inserted and engagingly stopped. In addition thereto, the heat generating element holder portion 2a is wrapped around the hook-received portion 43a of the retainer 43. In this state, the hook portion 43b is fitted to the hook-received portion 43a, whereby the heat generating element holder portion 2a is clamped.

As described in the foregoing, use of the retainers 43 of Example 4 in the heat generating unit according to the second embodiment allows both the end portions of the band-like heat generating element 2 to more surely be held by the retainers 43, whereby the heat generating element 2 can maintain the electrical and mechanical connection state at a prescribed position inside the container with great reliability.

### Example 5

In the following, a description will be given of the structure of each retainer 53 of Example 5 of the second embodiment with reference to FIG. 9. FIG. 9 is a plan view showing a state where, in the heat generating unit according to the second embodiment, the retainer 53 of Example 5 holds the heat generating element 2.

The retainer 53 of Example 5 is a variation of the retainer 43 of Example 4 described above, and is structured with a hook-received portion 53a around which the heat generating element holder portion 2a is wrapped as being folded back, a hook portion 53b fitted to the hook-received portion 53a, an engagement-stop portion 53c extended from the hook-received portion 53a, and a lead-out portion 53e leading from the hook-received portion 53a to the fixed portion 5. As shown in FIG. 9, the hook-received portion 53a, the engagement-stop portion 53c, and the lead-out portion 53e of the retainer 53 are formed by bending a single electrically conductive wire material that leads to the fixed portion 5. The hook-received portion 53a is formed in a straight manner in a direction perpendicular to the longitudinal direction of the heat generating element 2. Around the straight portion, the heat generating element holder portion 2a is wrapped as being folded back.

The retainer 53 of Example 5 is structured such that the lead-out portion 53e serving as the lead-out portion leading from one end of the hook-received portion 53a to the fixed portion 5 is led out from an edge in the width direction of the heat generating element holder portion 2a. On the other hand, the engagement-stop portion 53c serving as the tip of the hook-received portion 53a protrudes from the through hole 2h formed at the central position (the center axis position parallel to the longitudinal direction of the heat generating element 2) of the heat generating element holder portion 2a. Accordingly, the engagement-stop portion 53c of the hook-received portion 53a is structured to protrude in the direction where the fixed portion 5 is arranged on the center axis in the longitudinal direction of the heat generating element 2.

As shown in FIG. 9, to the hook-received portion 53a around which the heat generating element holder portion 2a is wrapped, the hook portion 53b is fitted so as to clamp the heat generating element holder portion 2a of the heat generating element 2. The hook portion 53b is formed with an elastic member, and structured so as to tightly grasp the hook-received portion 53a. At the center of the hook portion 53b, a through hole 53d is formed, the engagement-stop portion 53c serving as the tip of the hook-received portion 53a protrudes from the through hole 53d. The cross-sectional shape of the hook portion 53b taken along the longitudinal direction of the heat generating element 2 clamped by the hook portion 53b is a C-shape, so as to be fitted to the hook-received portion 53a being a rod-like portion, to tightly grasp the external surface of the hook-received portion 53a with the heat generating element holder portion 2a interposed therebetween.

While the description has been given taking up the exemplary case where, as to the retainer 53 of Example 5, the retainer 53 and the fixed portion 5 are integrally formed with the single wire material, it is also possible to employ a structure in which the retainer 53 and the fixed portion 5 are respectively structured with separate members, and then joined to each other.

As described above, into the through hole 2h of each heat generating element holder portion 2a serving as the end portion of the heat generating element 2, the engagement-stop portion 53c serving as the tip of the hook-received portion 53a is inserted and engagingly stopped. In addition thereto, the heat generating element holder portion 2a is wrapped around the hook-received portion 53a of the retainer 53. In this state, the hook portion 53b is fitted to the hook-received portion 53a, whereby the heat generating element holder portion 2a is clamped.

As described in the foregoing, use of the retainers 53 of Example 5 in the heat generating unit according to the second embodiment allows both the end portions of the band-like heat generating element 2 to more surely be held by the retainers 53, whereby the heat generating element 2 can maintain the electrical and mechanical connection state at a prescribed position inside the container with great reliability.

### Example 6

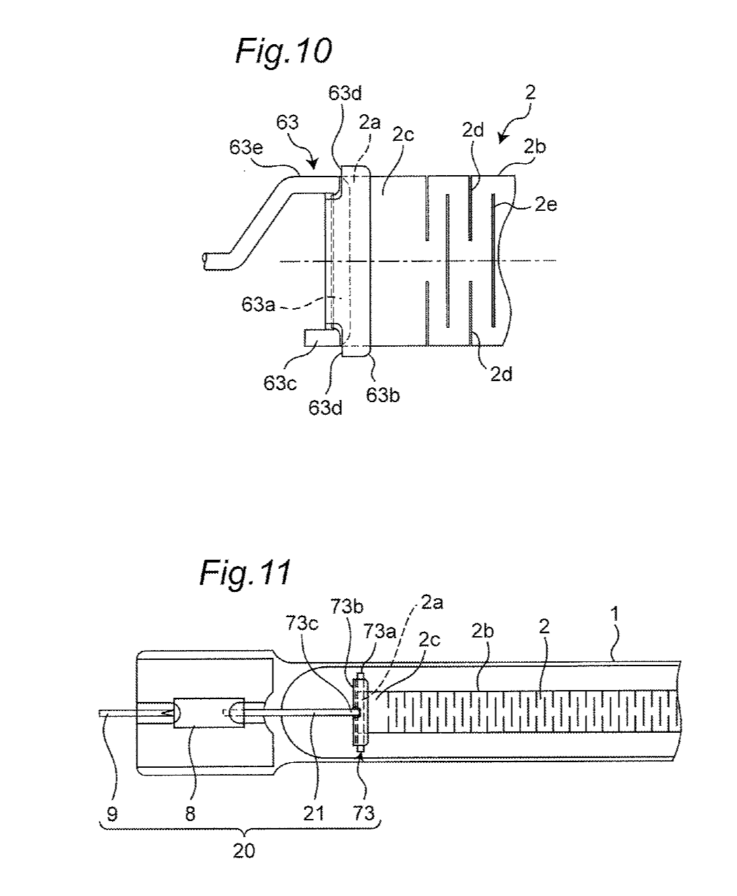

In the following, a description will be given of the structure of each retainer 63 of Example 6 in the second embodiment with reference to FIG. 10. FIG. 10 is a plan view showing a state where, in the heat generating unit according to the second embodiment, the retainer 63 of Example 6 holds the heat generating element 2.

The retainer 63 of Example 6 is a variation of the retainer 43 of Example 4 described above, and is structured with a hook-received portion 63a around which the heat generating element holder portion 2a is wrapped as being folded back, a hook portion 63b fitted to the hook-received portion 63a, an engagement-stop portion 63c extending from the hook-received portion 63a, and a lead-out portion 63e leading from the hook-received portion 63a to the fixed portion 5. As shown in FIG. 10, the hook-received portion 63a, the engagement-stop portion 63c, and the lead-out portion 63e of the retainer 63 are formed by bending a single electrically conductive wire material. The hook-received portion 63a is formed in a straight manner in a direction perpendicular to the longitudinal direction of the heat generating element 2. Around the straight portion, the heat generating element holder portion 2a is wrapped as being folded back.

The retainer 63 of Example 6 is structured such that the lead-out portion 63e serving as the lead-out portion leading from one end of the hook-received portion 63a to the fixed portion 5 is led out from one of cuts 63d respectively formed at both edges in the width direction of the heat generating element holder portion 2a. On the other hand, the engagement-stop portion 63c serving as the tip of the hook-received portion 63a is formed to protrude from the other one of the cuts 63d respectively formed at the edges in the width direction of the heat generating element holder portion 2a. Accordingly, in the hook-received portion 63a, a region between the cuts 63d and 63d formed at both the edges in the width direction of the heat generating element 2 is brought into contact.

As shown in FIG. 10, to the hook-received portion 63a around which the heat generating element holder portion 2a is wrapped, the hook portion 63b is fitted so as to clamp the heat generating element holder portion 2a of the heat generating element 2. The hook portion 63b is formed with an elastic member, and structured so as to tightly grasp the hook-received portion 63a. The hook portion 63b is provided with the cuts 63d and 63d respectively on its opposite sides. Accordingly, at one of the cuts 63d and 63d, the lead-out portion 63e serving as the lead-out portion to the fixed portion 5 is disposed; from the other, the engagement-stop portion 63c serving as the tip of the hook-received portion 63a protrudes. The cross-sectional shape of the hook portion 63b taken along the longitudinal direction of the heat generating element 2 clamped by the hook portion 63b is a C-shape, so as to be fitted to the hook-received portion 63a being a rod-like portion, to tightly grasp the external surface of the hook-received portion 63a with the heat generating element holder portion 2a interposed therebetween.

While the description has been given taking up the exemplary case where, as to the retainer 63 of Example 6, the retainer 63 and the fixed portion 5 are integrally formed with the single wire material, it is also possible to employ a structure in which the retainer 63 and the fixed portion 5 are respectively structured with separate members, and then joined to each other.

As described above, into the cut of each heat generating element holder portion 2a serving as the end portion of the heat generating element 2, the engagement-stop portion 63c serving as the tip of the hook-received portion 63a is inserted and engagingly stopped. In addition thereto, the heat generating element holder portion 2a is wrapped around the hook-received portion 63a of the retainer 63. In this state, the hook portion 63b is fitted to the hook-received portion 63a, whereby the heat generating element holder portion 2a is clamped.

As described in the foregoing, use of the retainers 63 of Example 6 in the heat generating unit according to the second embodiment allows the both the end portions of the band-like heat generating element 2 to more surely be held by the retainers 63, whereby the heat generating element 2 can maintain the electrical and mechanical connection state at a prescribed position inside the container with great reliability.

### Third Embodiment

In the following, a description will be given of a heat generating unit according to a third embodiment of the present invention with reference to FIG. 11. FIG. 11 is a plan view showing the structure of the heat generating unit according to the third embodiment, showing the left side portion of the heat generating unit. The heat generating unit according to the third embodiment has an elongated shape, and the right side and the left side are similarly structured.

The heat generating unit according to the third embodiment is different from the heat generating unit according to the first embodiment in the structure of power supply portions 20 respectively including retainers 73 respectively attached to both ends of the heat generating element 2. In connection with the heat generating unit according to the third embodiment, the constituents having the same function and structure as those of the heat generating unit according to the first embodiment are denoted by the same reference characters, and the description given in the first embodiment is applied thereto.

As shown in FIG. 11, the heat generating unit according to the third embodiment includes a container 1, an elongated band-like heat generating element 2 as a heat radiation membrane element, and the power supply portions 20 respectively provided at both end portions in the longitudinal direction of the heat generating element 2 for holding the heat generating element 2 at a prescribed position inside the container, and for supplying the heat generating element 2 with power.

The power supply portions 20 respectively provided at both the ends of the heat generating element 2 are structured to respectively include the retainers 73 attached to both the ends of the heat generating element 2, internal lead wires 21, molybdenum foils 8, and external lead wires 9. To the retainers 73 holding both the ends of the heat generating element 2, the internal lead wires 21 are respectively joined, and the internal lead wires 21 are respectively electrically connected to the external lead wires 9 that are led to the outside of the container from both the ends of the container 1 through the molybdenum foils 8 embedded in the sealed portion (welded portion) of both the end portions of the container 1.

Each of the retainers 73 used in the heat generating unit according to the third embodiment is structured with, similarly to the first embodiment described above, a rod-like hook-received portion 73a formed with an electrically conductive wire material, a hook portion 73b to which the hook-received portion 73a is fitted, and an engagement-stop portion 73c extending from the hook-received portion 73a and leading to the internal lead wire 21.

The engagement-stop portion 73c of each retainer 73 extends so as to lead from the central position (the center axis position parallel to the longitudinal direction of the heat generating element 2) of the hook-received portion 73a to the internal lead wire 21. The engagement-stop portion 73c is joined to the internal lead wire 21. Accordingly, in the heat generating unit according to the third embodiment, what is called a T-shape form is structured by the hook-received portion 73a and the engagement-stop portion 73c.

Around the rod-like hook-received portion 73a, the heat generating element holder portion 2a serving as an end portion of the heat generating element 2 is wrapped as being folded back. Here, the engagement-stop portion 73c extending from the hook-received portion 73a penetrates through a through hole formed at the heat generating element holder portion 2a. To the hook-received portion 73a around which the heat generating element holder portion 2a is wrapped around as being folded back, the hook portion 73b is fitted so as to clamp the heat generating element holder portion 2a of the heat generating element 2. A through hole is also formed at the hook portion 73b, the engagement-stop portion 73c also penetrates through the through hole. The hook portion 73b is formed with an elastic member, and structured so as to tightly grasp the hook-received portion 73a. The cross-sectional shape of the hook portion 73b taken along the longitudinal direction of the heat generating element 2 clamped by the hook portion 73b is a C-shape, so as to be fitted to the rod-like hook-received portion 73a to tightly grasp the external surface of the hook-received portion 73a with the heat generating element holder portion 2a interposed therebetween.

In a state where the retainers 73 hold the heat generating element 2 and the heat generating element 2 is tensely arranged inside the container, the site of each hook-received portion 73a around which corresponding one of the heat generating element holder portions 2a is wrapped as being folded back is arranged in the width direction perpendicular to the longitudinal direction of the heat generating element 2. In other words, the axial direction of the hook-received portion 73a being a rod-like element around which the heat generating element holder portion 2a is wrapped corresponds to the direction perpendicular to the longitudinal direction of the heat generating element 2.

As described in the foregoing, in the heat generating unit according to the third embodiment, because the retainers 73 engagingly stop the heat generating element holder portions 2a and clamp the heat generating element holder portions 2a, the heat generating element 2 is surely held without coming off from the retainers 73.

In the heat generating unit according to the third embodiment, both the end portions of the hook-received portion 73a of each retainer 73 is disposed close to the internal surface of the container 1. Accordingly, the length (i.e., the length in the direction perpendicular to the longitudinal direction of the heat generating element 2) of the hook-received portion 73a is set to be longer than the width of the heat generating element 2, and to be somewhat shorter than the inner diameter of the container 1. Accordingly, the hook-received portion 73a has a position regulating function as to the heat generating element 2 within the container. In the heat generating unit according to the third embodiment, use of the retainers 73 allows the heat generating element 2 to surely be held at a prescribed position inside the container while avoiding contact between itself and the container 1. Thus, a structure that does not require any additional position regulating member to perform the position regulating function (see the position regulating portion 4 in FIG. 1) is obtained.

Further, in the heat generating unit according to the third embodiment, as in the description given in connection with the first embodiment by the heat generating unit 2, by employing the structure in which the heat generating element 2 has an elastic force in its longitudinal direction, and the heat generating element 2 as being tensely arranged inside the container withstands the tensile force applied from its both sides, the heat generating unit according to the third embodiment can dispense with the spring portion 6 used in the heat generating unit according to the first embodiment shown in FIG. 1. As a result, the heat generating unit according to the third embodiment achieves a simplified structure of the power supply portions, thereby achieving a drastic reduction in the manufacturing cost, in addition to the effect described in connection with the above-described embodiments.

### Fourth Embodiment

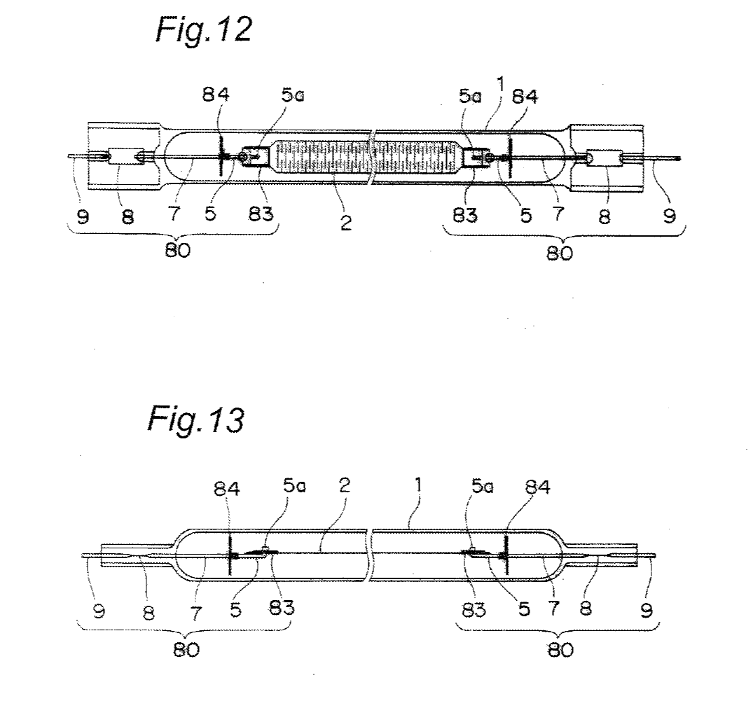

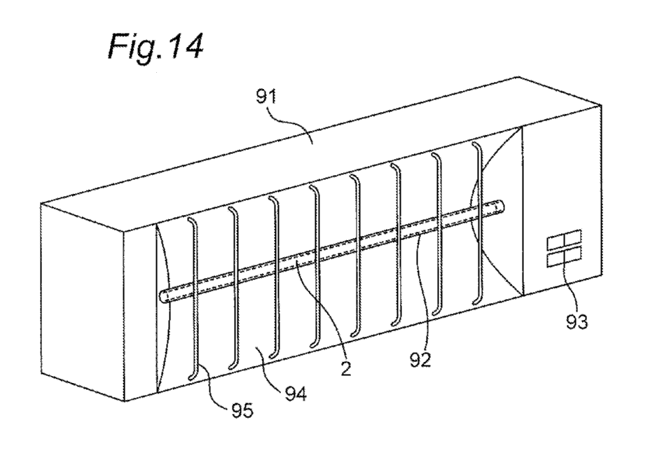

In the following, a description will be given of a heat generating unit according to a fourth embodiment of the present invention with reference to FIGS. 12 and 13. FIG. 12 is a plan view showing the structure of the heat generating unit according to the fourth embodiment. Because the heat generating unit has an elongate shaped, its intermediate portion is omitted from the drawing. FIG. 13 is a front view of the heat generating unit shown in FIG. 12. The heat generating unit according to the fourth embodiment has its right side and left side similarly structured, as shown in FIG. 12.

The heat generating unit according to the fourth embodiment is different from the heat generating unit according to the first embodiment in the structure of power supply portions 80 respectively including retainers 83 respectively attached to both ends of the heat generating element 2. In connection with the heat generating unit according to the fourth embodiment, the constituents having the same function and structure as those of the heat generating unit according to the first embodiment are denoted by the same reference characters, and the description given in the first embodiment is applied thereto.

As shown in FIGS. 12 and 13, the heat generating unit according to the fourth embodiment includes a container 1, an elongated band-like heat generating element 2 as a heat radiation membrane element, and the power supply portions 80 respectively provided at both end portions in the longitudinal direction of the heat generating element 2 for holding the heat generating element 2 at a prescribed position inside the container, and for supplying the heat generating element 2 with power.

The power supply portions 80 respectively provided at both the ends of the heat generating element 2 are structured to respectively include the retainers 83 attached to both the ends of the heat generating element 2, support rings 84, internal lead wires 7 each having a fixed portion 5, molybdenum foils 8, and external lead wires 9. To the retainers 83, the fixed portions 5 of the internal lead wires 7 are fixed, and the internal lead wires 7 are respectively electrically connected to the external lead wires 9 that are led to the outside of the container from both the ends of container 1 through the molybdenum foils 8 embedded in the sealed portion (welded portion) of both the end portions of the container 1.

As shown in FIGS. 12 and 13, to the internal lead wires 7, the support rings serving as position regulating portions having the position regulating function are attached. Each internal lead wire 7 leading to its corresponding fixed portion 5 is formed with a single wire material, e.g., a molybdenum wire, shaped into a coil shape.

It is to be noted that, while the description is given taking up the exemplary case where the internal lead wires 7 according to the fourth embodiment are each formed with a molybdenum wire, they may each be formed using a metal wire of a material such as tungsten, nickel, stainless steel or the like (of a round bar shape or of a flat plate shape).

As described in the foregoing, in the heat generating unit according to the fourth embodiment, the power supply portions 80 each structured with the retainer 83, the support ring 84, the internal lead wire 7, the molybdenum foil 8, and the external lead wire 9 are respectively provided at both sides of the heat generating element 2, so as to supply the heat generating element 2 with power and to tensely arrange the heat generating element 2 at a prescribed position inside the container.

The heat generating element 2 has its end portions clamped at its plane side and its back side by the retainers 83. The end portion of the fixed portion 5 of the internal lead wire 7 penetrates through a through hole formed substantially at the center of each of the retainers 83 and a through hole formed at each end portion of the heat generating element 2. Each fixed portion 5 has its end portion on the heat generating element side bent into what is called an L shape. The tip of the fixed portion 5 bent into an L-shape penetrates through and protrudes from the through hole of corresponding one of the retainers 83 clamping the heat generating element 2.

A protruding end portion 5a of the fixed portion 5 protruding from the through hole of the retainer 83 is provided with fall-out preventing means (coming-off preventing means). The protruding end portion 5a of the fixed portion 5 is in a crushed state as having undergone plastic deformation by press working, melting or the like. That is, the protruding end portion 5a at the fixed portion 5 is processed to have a shape greater than the diameter of the through hole of the retainer 83, so as to be provided with the fall-out preventing means.

Each support ring 84 of the heat generating unit according to the fourth embodiment is wrapped around the internal lead wire 7 and fixed thereto, and shaped in a coil-like manner.

The support ring 84 is structured to be wrapped in an adhered manner around corresponding internal lead wire 7 for supplying power to the heat generating element 2, and the support ring 84 is structured to have no current path leading from the external lead wire 9 to the heat generating element 2. In other word, the support ring 84 is structured so as not to intervene the current path in the internal lead wire 7. Thus, because the support ring 84 is structured such that no current to the heat generating element 2 flows, it does not generate heat by such a current. The support ring 84 according to the fourth embodiment has the position regulating function for the heat generating element 2, and also has the heat dissipation function to dissipate the heat transferred from the heat generating element 2.

While the description proceeds taking up the exemplary case where the support ring 84 is formed with the molybdenum wire, any material that has rigidity enough to regulate the position of the heat generating element 2, that exhibits an excellent heat conduction (heat dissipation function) and that is easy to be processed can be used as the support ring 84. For example, a metal material such as nickel, stainless steel, tungsten or the like can be used. It is to be noted that, the support ring 84 is not necessarily an indispensable constituent depending on the structure and specification of the heat generating unit, such as the length of the heat generating element 2, the dimensional difference between the inner diameter of the container 1 and the heat generating element 2, and the like.

In the heat generating unit according to the fourth embodiment, the material of the heat generating element 2 itself has an ability to expand and contract, and the shape pattern of the heat generating element 2 has the ability to expand and contract, no mechanism for absorbing the change caused by the expansion and contraction in the heat generating element 2 is required. In particular, because the heat generating element 2 used in the fourth embodiment has a small rate of thermal expansion, the heat generating element 2 that is arranged with application of a tensile force (i.e., tensely arranged) at the time of manufacture is capable of absorbing the expansion when generating heat by the ability to expand and contract of the heat generating element itself and that of the shape pattern of the heat generating element 2.

The heat generating element 2 used in the heat generating unit according to the fourth embodiment of the present invention is formed with a film-sheet material that includes a carbon-based substance as its main component, that is made up of a plurality of film sheet raw materials stacked in the thickness direction such that a space is formed between each of the layers, that exhibits an excellent two-dimensional isotropic thermal conduction, and that has a thermal conductivity of equal to or greater than 200 W/m·K. Accordingly, the band-like heat generating element 2 implements a heat source being free of temperature variations and providing uniform heat generation.

That is, the heat generating element 2 used in the heat generating unit according to the fourth embodiment is structured with the same manufacturing method and same material as the heat generating element 2 according to the first embodiment and the like described in the foregoing.

It is to be noted that, because the definition of “the two-dimensional isotropic thermal conduction” referring to the characteristic of the heat generating element of the present invention has been given in the description in connection with the first embodiment, it is not repeated herein. As to the high polymer film used as the film sheet raw material of the heat generating element 2 and the filler added to the high polymer film also, the description thereof has specifically been given in connection with the first embodiment in the foregoing and, therefore, it is not repeated herein.

As shown in FIG. 12, in the heat generating portion of the heat generating element 2 according to the fourth embodiment, a plurality of slits extend in the direction perpendicular to the longitudinal direction of the heat generating element 2. The plurality of slits formed in the heat generating portion are to regulate the direction of the current flow in the heat generating portion, and to adjust the resistance value. The slit shape formed in the heat generating portion includes perforated grooves, bottomed grooves and the like, according to the specification of the product with which the heat generating unit is used, the intended use and the like. As to the recess grooves, by modifying the depth in their thickness direction, the resistance value of the heat generating portion can be adjusted.

Further, by forming the slits in the heat generating element 2 according to the fourth embodiment, the ability to expand and contract of the slit shape in conjunction with the ability to expand and contract of the heat generating element itself allows the heat generating element 2 to have the characteristic of possessing the great ability to expand and contract.

### Fifth Embodiment

In the following, a description will be given of a heating apparatus according to a fifth embodiment of the present invention with reference to FIG. 14.

FIG. 14 is a perspective view showing an exemplary heating apparatus having installed therein the heat generating unit described in the first to fourth embodiments.

The heating apparatus shown in FIG. 12 shows a space-heating appliance 91 as an exemplary heating apparatus of the present invention. Inside the heating appliance 91, the heat generating unit of the present invention described in the first to fourth embodiments is installed. It is to be noted that, in the fifth embodiment, the heat generating unit is denoted by the reference character 92 for the purpose of description. The heating appliance 91 of the fifth embodiment is provided with constituents used in a general space-heating appliance, such as a temperature controller 93, a reflection plate 94, a protecting cover 95 and the like.

In the heating appliance 91 structured as above, by applying a rated voltage to the heat generating unit 92, a prescribed current flows through the heat generating element 2 in the heat generating unit 92 to generate heat, and the temperature rises with quick start-up. The heating appliance 91 according to the fifth embodiment is surely kept at a prescribed temperature desired by the user under the temperature control exerted by the temperature controller 93. As to the heat generating unit 92, a band-like heat generating element 2 having a plane is used as a heat source. Accordingly, the heat radiated from the plane has directivity. In the heating appliance 91 according to the fifth embodiment, the plane portion of the heat generating element 2 of the heat generating unit 92 is arranged to face the front side and the back side. Therefore, the heat radiated from the front side of the generating element 2 heats the heating target region on the front side of the heating appliance 91, and the heat radiated from the back side of the heat generating element 2 is reflected off the reflection plate 94 to heat the heating, target region. It is to be noted that, because the heat generating element 2 is formed band-like with the film sheet raw material, the heat quantity radiated sideways from the heat generating element 2 is very small, being small enough to be negligible as compared with the heat quantity radiated from the front side (back side). Accordingly, the heating appliance 91 according to the fifth embodiment possesses high directivity, and is capable of heating the heating target region and the heating target object with high efficiency.

The heat generating unit 92 installed in the heating apparatus of the present invention has the heat generating unit 2 described in the first to fourth embodiments. The heat generating element 2 is formed with the film sheet raw material possessing an excellent two-dimensional isotropic thermal conduction in which the thermal conductivity in the planar direction is the same, and has such a characteristic that, owing to its small heat capacity, the heat generating element 2 starts up quickly, and suffers from a small amount of inrush current. Accordingly, the heating appliance having installed therein the heat generating unit of the present invention as a heat source can implement a space-heating appliance that has an excellent characteristic of good response that realizes quick heating, and of being capable of heating a prescribed region with high thermal efficiency.

It is to be noted that, the heat generating unit of the present invention can be used as a heat source of a great variety of electronic/electric appliances being not limited to the space-heating appliance. For example, it can be used for a variety of appliances such as OA appliances having installed therein a high-temperature heat generating element, such as a copying machine, a facsimile, and a printer, or electric appliances that require a heat source, such as a cooking appliance, a drying machine, and a humidifier.

### Sixth Embodiment

Next, a description will be given of preferred embodiments of an image fixing device according to the present invention and an image forming device using the image fixing device with reference to the accompanying drawings. The image fixing device and the image forming device described herein have the heat generating unit described in the foregoing embodiments installed therein as a heat source.

As described in the foregoing, the inventors of the present invention have adopted a novel film sheet-like material (film sheet raw material) as a heat generating material for the heat generating element, which is completely different in material and manufacturing method from the heat generating element used in the conventional image fixing device. The film sheet-like material (film sheet raw material) to be adopted to a heat generating element used in a heat generating unit implementing a novel heat source of the image fixing device achieves high temperatures with high efficiency, being smaller in heat capacity owing to its being lightweight and thin, and having an excellent start-up characteristic.

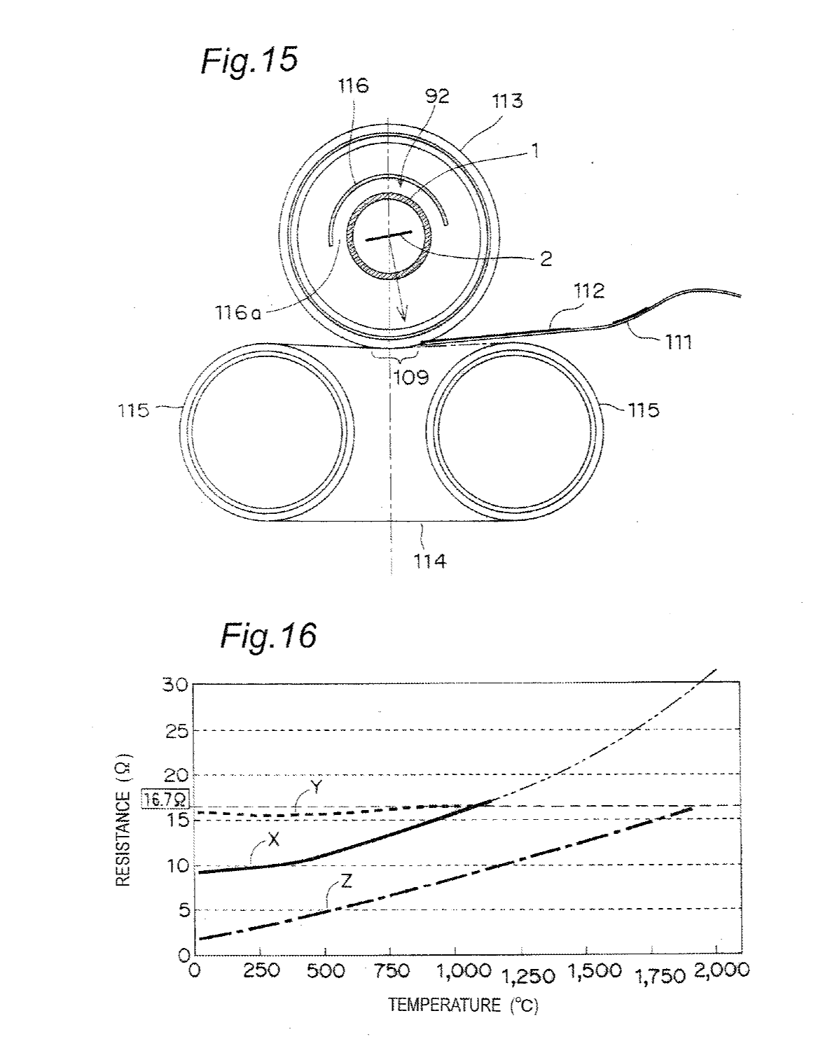

A description will be given of the image fixing device according to the sixth embodiment using the heat generating unit of the present invention with reference to FIGS. 15 to 19.

In an image forming process carried out by the image forming device, on the surface of a photosensitive drum uniformly charged by a charging device, an electrostatic latent image specified by an exposure device is formed, and in accordance with the electrostatic latent image, a toner image is formed by a developing device. The toner image formed on the surface of the photosensitive drum is transferred on a recording target member such as a paper conveyed by a transfer device. The recording target member, e.g., a paper, carrying thereon the unfixed toner image transferred in this manner, is conveyed to an image fixing device that fixes the image. The image fixing device pressurizes and heats the recording target member carrying the unfixed toner image, to thereby fix the unfixed toner image on the recording target member.

It is to be noted that, as to the image forming device according to the sixth embodiment, a description will be given of an image forming process of a single-color image. In a case where an image forming process of a multicolor image is carried out, the present invention is structured such that four sets of the above-described photosensitive drums are juxtaposed to one another so as to correspond to color toners of four colors. Then, toner images of respective colors are sequentially transferred to the transfer belt, and a multicolor image is gradually transferred on the recording target member. In this manner, the multicolor image transferred on the recording target member is pressurized and heated by the image fixing device so as to be fixed.

FIG. 15 shows the substantial structure of the image fixing device according to the sixth embodiment. As described in the foregoing, in the image forming process, the image fixing device pressurizes the recording target member carrying the unfixed toner image and heats the same at high temperatures, thereby melting the unfixed toner image so as to be fixed on the recording target member.

In FIG. 15, the image fixing device according to the sixth embodiment includes: a fixing roller 113 sewing as a heating element that heats an unfixed toner image 112 carried on a recording target member 111 to melt the same; a pressure belt 114 that pressurizes the recording target member 111 carrying the unfixed toner image 112 by pressing the same against the fixing roller 113, and that fixes by use of the pressure the unfixed toner image 112 to the recording target member 111; and two pressure rollers 115 and 115 that rotate the pressure belt 114 so as to press the same against the fixing roller 113 with a desired force. In the image fixing device according to the sixth embodiment, the pressurizing element is structured with the pressure belt 114 and the pressure rollers 115 and 115.

It is to be noted that, while the image fixing device according to the sixth embodiment is structured to convey the recording target member 111 by the pressure belt 114 to a nip portion 109 serving as the fixing region, to achieve fixation by use of pressure, it is also possible to structure the image fixing device according to the sixth embodiment such that the pressure rollers 115 and 115 disposed to face the fixing roller 113 pressurize the recording target member 111 by pressing the recording target member 111 against the fixing roller 113. Further, the description of the image fixing device according to the sixth embodiment proceeds taking up an exemplary case where the heating element is structured with the fixing roller 113, it is also possible to structure the heating element with a belt rotated by rollers.

As shown in FIG. 15, inside the fixing roller 113, the heat generating unit 92 having the heat generating element 2 is provided. In the heat generating unit 92, the heat generating element 2 is a heat source for heating the fixing roller 113, and the heat generating element 2 is enclosed inside the container 1. Around the elongated container 1 enclosing the heat generating element 2 therein, a tubular reflection portion 116 having an opening is disposed. The reflection portion 116 is made of stainless steel, and has its internal surface mirror-finished. The opening 116a formed at the reflection portion 116 extends in parallel to the longitudinal direction of the heat generating element 2. The opening 116a of the reflection portion 116 is an aperture for emitting the heat radiated from the heat generating element 2 together with the heat reflected off the internal surface of the reflection portion 116 toward the nip portion 109 of the fixing region implemented by the fixing roller 113 and the pressure belt 114. In the image fixing device according to the sixth embodiment, the opening of the reflection portion 116 is directed such that the region heated by the heat generating unit 92 is located on the most upstream side in the conveying direction of the recording target member 111 in the nip portion 109. Further, the plane side of the band-like heat generating element 2 of the heat generating unit 92 is also directed to the most upstream side in the conveying direction of the recording target member 111 in the nip portion 109.

While the description of the image fixing device according to the sixth embodiment proceeds taking up the structure in which the reflection portion 116 is disposed around the heat generating unit 92, the image fixing device of the present invention can be implemented with a structure in which the reflection portion is dispensed with, and the heat generating unit 92 heats the surrounding fixing roller 113.

In the image fixing device according to the sixth embodiment, the fixing roller 113 is structured with a plurality of layers such that the heat radiated from the heat generating unit 92 is absorbed by the fixing roller 113 with high efficiency and such that the heat is retained therein. The internal surface of the fixing roller 113 is provided with an infrared absorption layer that absorbs and not reflects the heat (infrared radiation) from the heat generating unit 92.

While the description of the image fixing device according to the sixth embodiment proceeds taking up the exemplary case where a single heat generating unit 92 is provided, the heat generating unit 92 may be provided in a plurality of numbers. When a plurality of heat generating units 92 are provided, respective center axes in the longitudinal direction of the heat generating units 92 are arranged on a straight line so as to be perpendicular to the conveying direction of the recording target member 111. The image fixing device having a plurality of heat generating units 92 installed inside the fixing roller 113 implements a structure that permits selection of the heat generating unit 92 to be supplied with power, in accordance with the size of the recording target member 111. Because the heat generating element 2 of the heat generating unit 92 used in the image fixing device of the present invention is a film sheet-like band element, the heat radiation amount from its plane portion is extremely greater than the heat radiation amount from its sideway face portion, whereby high directivity is exhibited. Accordingly, in the image fixing device provided with a plurality of heat generating units 92, it becomes possible to set the region that is heated in an overlapping manner by adjacent heat generating units 92 to be reduced in size. Thus, it becomes possible to heat around the nip portion uniformly with high efficiency.

Further, in the image fixing device according to the sixth embodiment, irrespective of the number of the installed heat generating unit(s) 92 being singular or plural, because the film sheet-like heat generating element 2 used in the heat generating unit 92 exhibits high directivity and has an excellent start-up characteristic as will be described later, it becomes possible to carry out the image fixing process in the image forming process with high efficiency at high speeds.

As to the structure of the heat generating unit 92 of the image fixing device according to the sixth embodiment, because the heat generating unit described in the first to third embodiments is used therefor, the detailed description thereof is not repeated herein.

In the following, a description will be given of the characteristic of the heat generating element 2 of the heat generating unit 92 used as a heat source in the image fixing device according to the sixth embodiment of the present invention in comparison with the conventional ones.

First, a heat source having been used in a conventional image fixing device will be described.

A halogen heater having been used as a heat source in a conventional image fixing device is advantageous in that it starts up quickly when power is turned on. On the other hand, the halogen heater has been suffering from the following problems: a great inrush current occurs in the halogen heater, which necessitates a large-capacity control circuit in order to control turn on/off operation of the halogen heater; which in turn invites an increase in size, and becomes disadvantageous also from a cost-effectiveness standpoint. Further, the halogen heater is associated with a problem that the control exerted over the halogen heater causes a fluorescent lamp, which is a nearby lighting device, to flicker (flicker phenomenon).

A carbon heater suffers little from an inrush current. Therefore, the problems such as a reduction in voltage when power to the heat generating element is turned on, and the flicker of a fluorescent lamp (flicker phenomenon), are alleviated. However, the carbon heater takes time to start up as well as to carry out the fixing process in the image forming process. Therefore, it is associated with a problem of an increase in energy consumption when carrying out the fixing process.

On the other hand, in a carbon heater using a plate-like heat generating element formed with a mixture of crystallized carbon such as graphite, a resistance value regulating material, and amorphous carbon, the carbon-based substance has high infrared emissivity of 78 to 84%. Accordingly, use of the carbon-based substance as a heat generating element brings about an increase in the infrared emissivity from the carbon heater, whereby it becomes possible to structure a highly efficient heat source. However, the heat generating element used as the carbon heater is a plate-like heat generating element having a thickness (for example, several mm), having a considerable heat capacity. Thus, it is associated with a problem that it takes time to start up when power is turned on.

The heat generating element having been used as the carbon heater has such a temperature-resistance characteristic that the resistance value is substantially constant irrespective of the temperature of its heat generating element, and the inrush current occurs rarely. Thus, because the inrush current occurs rarely in the heat generating element having been used as the conventional carbon heater, the problems such as a reduction in voltage when power to the heat generating element is turned on and the flicker of a fluorescent lamp (flicker phenomenon) are alleviated. However, use of the heat generating element as a heat source is associated with the following problems: it takes time to start up as well as to carry out the fixing process in the image forming process, and an increase in energy consumption when carrying out the fixing process occurs.

The inventors have conducted a comparative experiment in the temperature characteristic, which is the relationship between temperature [° C.] and resistance [Ω], by structuring 100V- and 600 W-specification heaters for each of the following: the heat generating element 2 of the heat generating unit 92 used in the image fixing device according to the sixth embodiment of the present invention; the heater using the elongated plate-like heat generating element whose main component is the carbon-based substance, which has been used as the heat source in the conventional image fixing device (hereinafter, referred to as the carbon heater for short); and a heater using a halogen lamp (hereinafter, referred to as the halogen heater for short) as a reference example.

It is to be noted that the heat generating unit 92 used in the following experiment (the experiment of which result is shown in FIGS. 16 to 19) is the heat generating unit (see FIGS. 12 and 13) described in the fourth embodiment.

FIG. 16 is a temperature characteristic diagram showing the relationship between temperature [° C.] and resistance [Ω] as to each of the heat generating element 2 of the heat generating unit 92, the carbon heater being the conventional heat source, and the halogen heater. In FIG. 16, the solid line X represents the temperature characteristic of the heat generating element 2 of the heat generating unit 92 used in the image fixing device according to the present invention. Similarly, in FIG. 16, the broken line Y represents the temperature characteristic of the carbon heater, and the alternate long and short dash line Z represents the temperature characteristic of the halogen heater as the reference example.

As shown in FIG. 16, the heat generating element 2 of the heat generating unit 92 used in the image fixing device according to the sixth embodiment of the present invention has the positive temperature coefficient characteristic in which the higher the temperature becomes, the greater the resistance becomes. According to the experiment, for example, when the temperature of the heat generating element 2 was 20° C. (when not energized), the resistance value was 9.2Ω; when the temperature where lighting equilibrium was reached was 1120° C., the resistance value was 16.7Ω. Accordingly, the rate of change of the resistance value (resistance change rate) of the heat generating element 2 between the state where not being energized and the state where lighting equilibrium is reached is 1.81. It is to be noted that, as used herein, the state where lighting equilibrium is reached refers to a state where the heat generation temperature of the heat generating element becomes constant, which is established after a voltage (of 100 V, for example) is applied to the heater and power is supplied thereto, allowing the current to flow through the heat generating element. Further, the resistance change rate refers to a value obtained by dividing a resistance value of the heat generating element 2 when lighting equilibrium is reached by energization by a resistance value without energization.

On the other hand, the temperature characteristic of the carbon heater serving as the conventional heat generating element represented by the broken line Y shows substantially constant resistance value despite changes in temperature. According to the experiment of the inventors, when the temperature of the carbon heater was 20° C. (without energization), the resistance value was 15.9Ω; when the temperature where lighting equilibrium was reached was 1030° C., the resistance value was 16.7Ω. Accordingly, the resistance change rate of the carbon heater between the state without energization and when lighting equilibrium is reached is 1.05. Further, as to the halogen heater represented by the alternate long and short dash line Z, when the temperature was 20° C. (without energization), the resistance value was 1.8Ω; when the temperature where lighting equilibrium was reached was 1830° C., the resistance value was 16.7Ω. Accordingly, the resistance change rate of the halogen heater between the state without energization and when lighting equilibrium is reached is 9.28.

It is to be noted that, in a case where the heat generating element 2 used in the image fixing device according to the sixth embodiment was used to supply power such that the temperature when lighting equilibrium was reached became 500° C. also, the start-up characteristic represented by the solid line X in FIG. 16 was exhibited, and the resistance value at 500° C. was 11.0Ω. Accordingly, the resistance change rate of the heat generating element 2 between the state without energization and the state where lighting equilibrium is reached is 1.2 (=11.0/9.2).

In a case where the heat generating element 2 used in the image fixing device according to the sixth embodiment was used to supply power such that the temperature when lighting equilibrium was reached became 2000° C., the start-up characteristic represented by the alternate long and two short dashes line following the solid line X in FIG. 16 was exhibited, and the resistance value at 2000° C. was 32.2Ω. Accordingly, the resistance change rate of the heat generating element 2 between the state without energization and the state where lighting equilibrium is reached is 3.5 (=32.2/9.2).

As described in the foregoing, the heat generating element 2 of the heat generating unit 92 used in the image fixing device according to the sixth embodiment has the positive temperature coefficient characteristic in which the higher the temperature becomes, the greater the resistance becomes. For example, when the temperature where lighting equilibrium was reached was set to 500° C., the resistance value when lighting equilibrium was reached was 11.0Ω, and the resistance change rate was 1.2. When the temperature where lighting equilibrium was reached was set to 2000° C., the resistance value when lighting equilibrium was reached was 32.2Ω, and the resistance change rate was 3.5. Thus, the characteristic where the temperature and the resistance value are substantially proportional to each other is exhibited.

Further, the heat generating element 2 of the heat generating unit 92 used in the image fixing device according to the sixth embodiment provided the resistance change rate of 1.81, which was obtained by dividing the resistance value when lighting equilibrium was reached with energization of rated power by the resistance value without energization. Thus, the heat generating element 2 of the heat generating unit 92 used in the image fixing device of the present invention has a certain resistance (9.2Ω) even when not being energized, and has the resistance change rate between the state without energization and the state where lighting equilibrium is reached is 1.81.

By setting the electric power or the heater temperature such that the resistance change rate falls within a range of 1.2 to 3.5, the heat generating element 2 of the heat generating unit 92 of the present invention exerts the effect of being capable of generating heat at a desired temperature with great accuracy, and achieving quicker start-up when generating heat when the heat generating unit 92 is lit, without inviting occurrence of a great inrush current. It is to be noted that, when the resistance change rate between the state without energization and the state where lighting equilibrium is reached falls within a range of 1.2 to 3.5, the start-up when generating heat becomes quicker and, as will be described later, the appliance for controlling the heat generating unit 92 is not required to be of a large capacity. If a heat generating element whose resistance change rate is smaller than 1.2 is used, then what is obtained is an image fixing device whose temperature is low, with a small inrush current and sluggish start-up. On the other hand, if a heat generating element whose resistance change rate exceeds 3.5 is used, then it becomes necessary to provide, greater room for each of the constituents for securing reliability, because a great inrush current occurs. This poses a problem of an increase in the volume of the constituents, which eventually incurs an increase in both the manufacturing cost and the size of the device.

On the other hand, when the carbon heater is used as the heat source, because its resistance value is substantially constant irrespective of the temperature, when being lit, no inrush current occurs and a substantially constant current flows through. Accordingly, use of the carbon heater as the heat source poses a problem that the rising speed (start-up) of heat generation temperature is sluggish, and it takes time until a prescribed temperature is reached. Consequently, when it is used as the heat source of the image fixing device, there arises a problem that it takes time until the nip portion reaches a desired temperature, taking time to carry out the image fixing process as well as to start up quickly.

The specific resistance value of the heat generating element 2 of the heat generating unit 92 is 250 μΩ·cm; the specific resistance value of carbon of the carbon heater is 3000 to 50000 μΩ·cm; and the specific resistance value of tungsten of the halogen heater is 5.6 μΩ·cm. As stated above, the specific resistance value of carbon is extremely higher than the materials of the other heaters. This realizes the design with small current variations and with little occurrence of the inrush current when power is turned on. Further, while the specific resistance value of the heat generating element 2 is smaller than the specific resistance value of carbon, it is greater than the specific resistance value of tungsten. This makes it possible to design the heat generating element 2 easier as compared with the heat generating element of tungsten.

Further, the density of the heat generating element 2 of the heat generating unit 92 is 0.5 to 1.0 g/m³ (subjected to vary depending on the thickness); the density of carbon of the carbon heater is 1.5 g/m³; and the density of tungsten of the halogen heater is 19.3 g/m³. Thus, because the density of the heat generating element 2 is lower than the materials of the other heaters, and the heat generating element 2 is a band-like thin membrane element, it can be understood that its heat capacity is extremely smaller than those of the other heaters, and it starts up quicker.

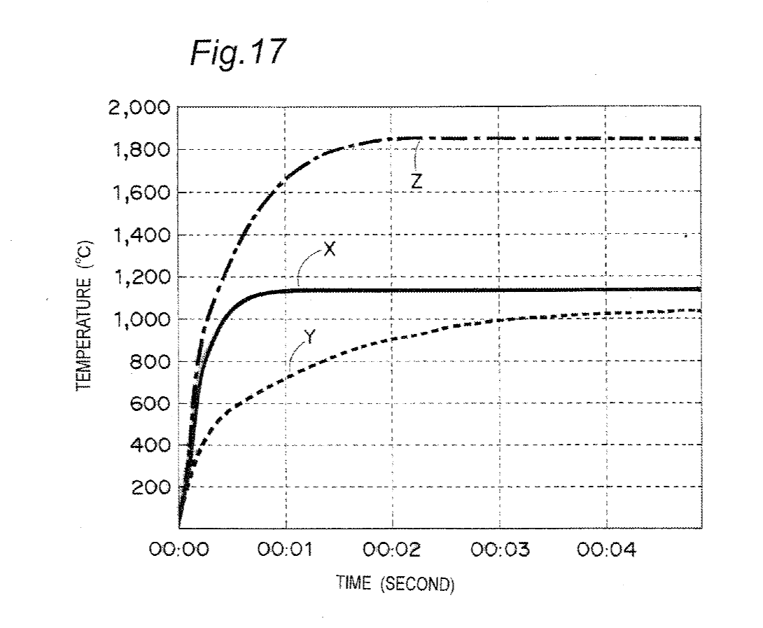

FIG. 17 is a graph showing an examination result of the start-up characteristic as to each of the heat generating unit 92 used in the image fixing device of the present invention, and the carbon heater and the halogen heater both serving as the conventional heaters.

In FIG. 17, the solid line X represents the start-up characteristic of the heat generating unit 92 used in the image fixing device of the present invention. In FIG. 17, the broken line Y represents the start-up characteristic of the carbon heater using the aforementioned elongated plate-like heat generating element whose main component is the carbon-based substance, and the alternate long and short dash line Z represents the start-up characteristic of the halogen heater using the halogen lamp. In the characteristic diagram shown in FIG. 17, using the heaters structured in accordance with the 100V- and 600 W-specification, the start-up characteristics from lighting up until after a lapse of 5 seconds are shown.

As can be seen from respective start-up characteristics shown in FIG. 17, the start-up characteristic of the heat generating unit 92 used in the image fixing device of the present invention (the solid line X in FIG. 17) shows quicker start-up as compared with the start-up characteristic of the carbon heater being the conventional heat source (the broken line Y in FIG. 17). According to the experiment of the inventors, the time it took to reach the temperature 90% as great as the temperature when lighting equilibrium was reached was 0.6 seconds for the heat generating unit 92, whereas it was 2.7 seconds for the carbon heater. The time it took to reach the temperature 90% as great as great as the temperature when lighting equilibrium was reached was 1.1 seconds for the halogen heater.

As described above, because the start-up time until when lighting equilibrium is reached differs among the heaters, i.e., the heat generating unit 92, the carbon heater, and the halogen heater, the power consumption at the start-up time will greatly differ among them. For example, while there is a current variation upon activation in each heater used in the experiment described above, assuming that 6 A is consumed, the time it took to reach the temperature 90% as great as the temperature when lighting equilibrium was reached was 0.6 seconds for the heat generating unit 92 and, therefore, the power consumption during that time is about 360 W·S. On the other hand, the time it took to reach the temperature 90% as great as the temperature when lighting equilibrium was reached was 2.7 seconds for the carbon heater and, therefore, the power consumption during that time is about 1620 W·S. Further, the time it took to reach the temperature 90% as great as the temperature when lighting equilibrium was reached was 1.1 seconds for the halogen heater and, therefore, the power consumption during that time is about 600 W·S.

Thus, the power consumption until when lighting equilibrium is reached in the heat generating unit 92 is drastically smaller than those of the other heaters. Because the fixing process is frequently performed in the image fixing device and the turn-on and turn-off operations are repeatedly performed, this difference becomes extremely great. Hence, the energy consumption is drastically reduced.

It is to be noted that, the halogen heater exhibits the relatively short reaching time because its resistance value without energization is low and a great inrush current occurs at the initial power-on, as shown in FIG. 16. The foregoing calculation of the power consumption of the halogen heater is based on the assumption that 6 A is consumed. However, practically, during a period between 0 to 5 seconds at the initial turn-on of the halogen heater until stabilized, a great inrush current flows through. Accordingly, the power consumption during that period becomes a further greater value.

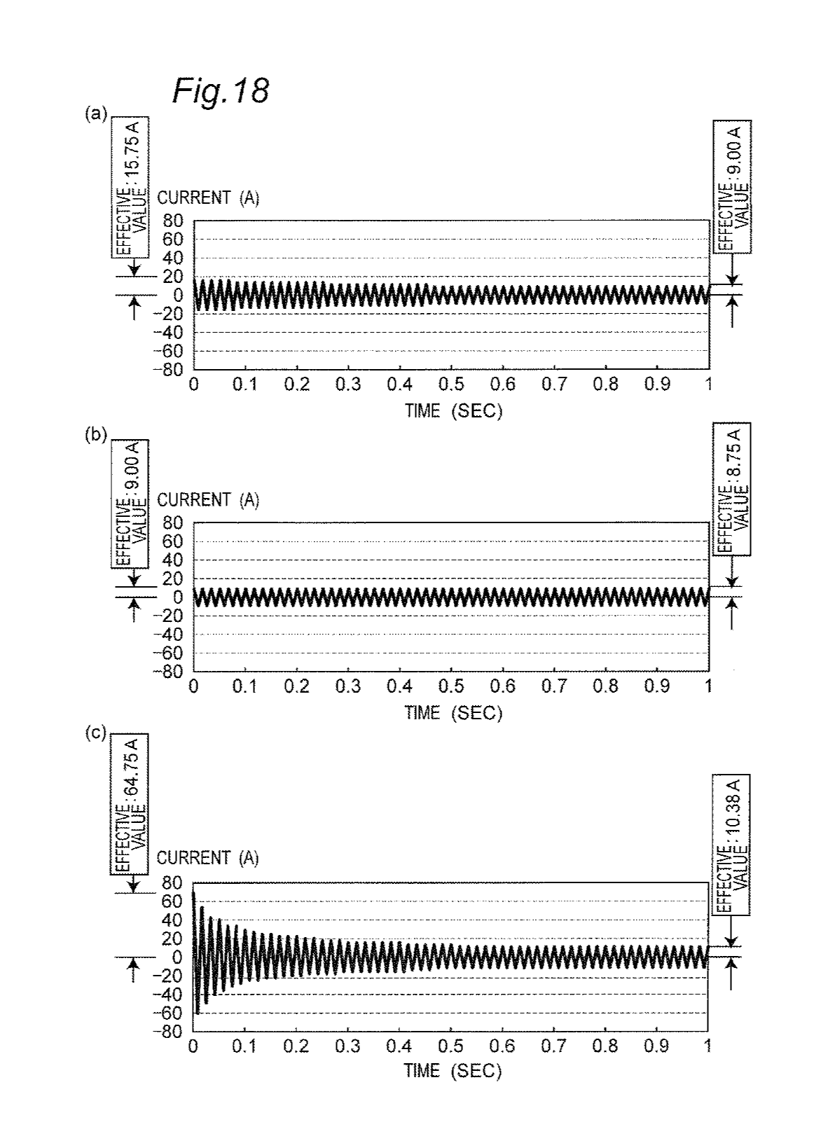

FIG. 18 shows a comparison of the inrush current at initial turn-on among the heaters, showing each current waveform from initial turn-on until after a lapse of 1.0 second. In FIG. 18, (a) is the current waveform at start-up of the heat generating unit 92 used in the image fixing device of the present invention; (b) is the current waveform at start-up of the conventional carbon heater; and (c) is the current waveform at start-up of the halogen heater.

As shown in (a) of FIG. 18, with the heat generating unit 92 used in the image fixing device of the present invention, the effective value of the current at initial turn-on was 15.75 A, and the effective value of the current after a lapse of 1.0 second from the initial turn-on was 9.00 A. That is, with the heat generating unit 92, while occurrence of the inrush current can be seen, the magnitude thereof is twice as great as the current when lighting equilibrium is reached, or smaller than that.

As to the carbon heater shown in (b) of FIG. 18, the inrush current occurred little; the effective value of the current at initial turn-on was 9.00 A; and the effective value of the current after a lapse of 1.0 second from the initial turn-on was 8.75 A. On the other hand, as to the halogen heater shown in (c) of FIG. 18, a great inrush current occurred; the effective value of the current at initial turn-on was 64.75 A; and the effective value of the current after a lapse of 1.0 second from the initial turn-on was 10.38 A. As to the halogen heater, as shown in FIG. 16 (by the alternate long and short dash line Z), the resistance change rate between a state without energization and a state where lighting equilibrium is reached is a great value of 9.27, which is at least five times greater and, therefore, a great inrush current occurs. While occurrence of such a great inrush current exhibits the quicker start up characteristic, it is associated with a problem that a large capacity element that withstands the large current must be used in any appliance in which the halogen heater is used. For example, a thyristor as a switching element of a large current capacity is required. Further, as to a mechanical contact also, a contact of a large breaking capacity must be used in order not to be welded by a large current. Further, as to the halogen heater, it is difficult to exert voltage control due to its principle of heat generation (halogen cycle), and what can be controlled is solely the switching between on and off. Accordingly, it is associated with a problem that the temperature control with great accuracy is impossible.

As described in the foregoing, with the heat generating unit 92 used in the image fixing device according to the sixth embodiment of the present invention, the rate of change between the state without energization and the state where lighting equilibrium is reached is 1.81, and it has the characteristic that a certain amount of inrush current occurs. Therefore, it implements a heat source that starts up quicker; that has shorter time until lighting equilibrium is reached; and that has an excellent response. Consequently, use of the heat generating unit 92 as the heat source of the image fixing device improves the performance as the image fixing device, and implements an appliance that achieves energy savings with its small energy consumption.

Further, because the heat generating unit 92 used in the image fixing device according to the sixth embodiment of the present invention has such a characteristic that it is free of occurrence of a great inrush current that the halogen heater suffers from, it is not necessary to prepare a large-capacity appliance that withstands a large current as the appliance with which the heat generating unit 92 is used, whereby a reduction in the manufacturing cost and miniaturization can be achieved. It is to be noted that, as used herein, the great inrush current refers to the current at initial turn-on that is at least five times as great as the current after a lapse of 1.0 second.

In the heat generating unit used in the image fixing device according to the sixth embodiment of the present invention, it is set such that the current at initial turn-on becomes 3.5 times as great as the current after a lapse of 1.0 second from the initial turn-on, or smaller than that. In this manner, by setting such that, in the heat generating unit, the current at initial turn-on becomes 3.5 times as great as the current after a lapse of 1.0 second from the initial turn-on, or smaller than that, a heat source that starts up quickly and that has an excellent response is implemented. Further, it is not necessary to use a large-capacity appliance that withstands a large current as the appliance with which the heat generating unit is used, whereby a reduction in the manufacturing cost and miniaturization can be achieved.

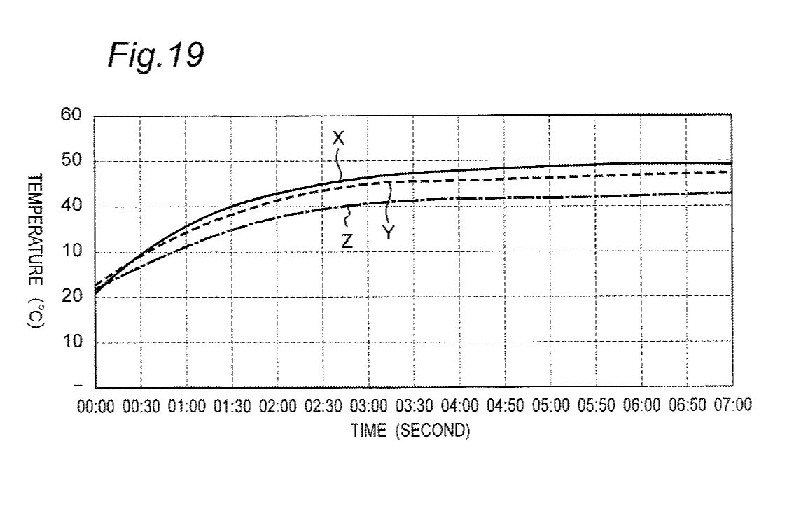

FIG. 19 shows a measurement result of copper plate temperatures when a copper plate as a heating target object is heated by each of the heat generating unit 92, the carbon heater, and the halogen heater. In FIG. 19, the solid line X represents the temperature rise curve of the copper plate by use of the heat generating unit 92. The broken line Y represents the temperature rise curve of the copper plate by use of the carbon heater, and the alternate long and short dash line Z represents the temperature rise curve of the copper plate by use of the halogen heater.

In the copper plate temperature measurement experiment shown in FIG. 19, a copper plate piece measuring 65 mm (L)×65 mm (W)×0.5 mm (t) was used as the heating target object, and the heated face facing the heater serving as the heating element was painted black. Each of the heaters used was an elongated heater having a length of 300 mm, and of 100V- and 600 W-specification. The opposing distance between the copper plate piece and each heater was 300 mm, and the copper plate temperature was measured by attaching a thermocouple to the back surface of the copper plate piece, which is counter to the heated face.

As shown in FIG. 19, the heat generating unit 92 used in the image fixing device according to the sixth embodiment of the present invention raises the temperature of the copper plate serving as the heating target object the fastest and to the high temperature, despite the heat generating unit 92 having the same specification as the other heaters. As to the halogen heater, while the tungsten wire serving as its heat generating element achieves the high temperature, the temperature rise of the heating target object is sluggish because the emissivity of tungsten (about 0.18) is small. While the temperature rise caused by the carbon heater is faster than that caused by the halogen heater, it is more sluggish than the temperature rise caused by the heat generating unit 92, and the equilibrium temperature is also lower. This is because the heat generating element 2 of the heat generating unit 92 exhibits the emissivity of 0.9, which is higher as compared with the emissivity of carbon, i.e., 0.85.

Accordingly, it can be understood that the heat generating unit 92 used in the image fixing device according to the present invention can heat the heating target object highly efficiently and quickly.

As has been described in the foregoing, the heat generating element 2 used in the image fixing device according to the sixth embodiment has such excellent characteristics that it is lightweight and thin, being small in heat capacity, and that it quickly starts up to establish lighting equilibrium upon energization. Accordingly, because the heat generating unit having the heat generating element that responses in an excellent manner and that heats highly efficiently is used in the image fixing device according to the sixth embodiment, heating of the fixing region becomes quicker, whereby energy savings can be achieved and the quick start can be realized. Further, the image fixing device according to the sixth embodiment is free of a great inrush current at an initial stage of heating when lit, the problems such as the occurrence of voltage drop, the occurrence of a flicker, i.e., a fluorescent lamp flickers, are overcome.

The heat generating unit and the heating apparatus of the present invention uses the heat generating element structured with the film sheet raw material whose main component is a carbon-based substance, having the two-dimensional isotropic thermal conduction, possessing flexibility, pliability, and elasticity, having a thermal conductivity of equal to or greater than 200 W/m·K, and having a thickness of equal to or smaller than 300 μm. The heat generating element has the excellent characteristic in exhibiting a high emissivity that is equal to or higher than 80%. The heat generating unit using the heat generating element as a heat source realizes highly efficient heating. Further, use of the heat generating unit of the present invention in the heating apparatus makes it possible to provide a heating apparatus having great safety and reliability, and which can be manufactured easily. Still further, the image fixing device and the image forming device using the heat generating unit of the present invention provide the effect being advantageous in that the heating target object can be heated with a desired heat distribution at high temperatures with high-efficiency in the fixing process, that they can start up of quickly, and that they can reduce the energy consumption.

### INDUSTRIAL APPLICABILITY

The present invention provides a heat generating unit and a heating apparatus that can structure a heat source exhibiting great safety and reliability, and that are excellent in work efficiency so as to be highly productive. Therefore, the present invention is useful in the field of electronic/electric appliances where a heat source is required.

1. A heat generating unit, comprising:
a band-like heat generating element that is formed with a film sheet of a material including a carbon-based substance and that has a two-dimensional isotropic thermal conduction;
power supply portions that supply electric power to opposing both ends of the heat generating element; and
a container that contains the heat generating element and part of the power supply portions, wherein
the power supply portions inside the container each have a retainer that holds a heat generating element holder portion located at each of both the ends of the heat generating element, and an internal lead wire portion connected to the retainer, the retainer being structured to have a hook-received portion bearing the heat generating element holder portion, an engagement-stop portion extending from the hook-received portion so as to engagingly stop the heat generating element, and a hook portion attached to the hook-received portion so as to clamp the heat generating element holder portion.

2. The heat generating unit according to claim 1, wherein
in the hook-received portion, a site bearing the heat generating element holder portion extends in a width direction perpendicular to a longitudinal direction of the heat generating element.

3. The heat generating unit according to claim 2, wherein
one of a hole and a notch is formed at the heat generating element holder portion, and the engagement-stop portion is disposed inside one of the hole and the notch.

4. The heat generating unit according to claim 3, wherein
the engagement-stop portion disposed inside one of the hole and the notch is joined to the internal lead wire portion.

5. The heat generating unit according to claim 4, wherein
the hook-received portion and the engagement-stop portion are integrally formed with a wire material, the hook-received portion being structured by the wire material being bent so as to allow the heat generating element holder portion to be wrapped around, and the engagement-stop portion being structured to lead to the internal lead wire portion.

6. The heat generating unit according to claim 4, wherein
the hook-received portion and the engagement-stop portion are integrally formed with a wire material, the engagement-stop portion being disposed inside the notch formed at an edge portion in the width direction of the heat generating element holder portion.

7. The heat generating unit according to claim 1, wherein
the hook-received portion and the engagement-stop portion are formed with a single wire material, the hook-received portion and the engagement-stop portion being formed by the wire material being bent.

8. The heat generating unit according to claim 1, wherein
the hook portion is formed with an elastic material, the hook portion being structured so as to be attached to the hook-received portion by an elastic force.

9. The heat generating unit according to claim 1, wherein
the hook-received portion is formed with an electrically conductive material.

10. The heat generating unit according to claim 1, wherein
the retainer has a position regulating function for disposing the heat generating element at a prescribed position inside the container, an end portion in the retainer being disposed close to an internal surface of the container.

11. The heat generating unit according to claim 1, wherein
the heat generating element has a structure having an elastic force that absorbs a thermal contraction and a thermal expansion in the heat generating element itself, the internal lead wire portion supplying the retainer with the electric power lacking an elastic structure.

12. The heat generating unit according to claim 1, wherein
the heat generating element has an interlayer structure formed of the material including the carbon-based substance.

13. The heat generating unit according to claim 1, wherein
the container is formed with one of a heat resistant glass tube and a heat resistant ceramic tube, being filled with an inert gas and sealed at the power supply portions.

14. A heating apparatus having installed therein the heat generating unit according to claim 1 as a heat source.

15. An image fixing device, comprising:
a heating element that heats a recording target member carrying an unfixed toner image with a heat generating unit according to claim 1 as a heat source; and
a pressurizing element that is arranged so as to oppose to the heating element, and that pressurizes against the heating element with the recording target member interposed, wherein
the heating element has a heat generating element as a heat source, the heat generating element being formed to be a band-like film sheet of a material including a carbon-based substance, and the heat generating element having a two-dimensional isotropic thermal conduction.

16. The image fixing device according to claim 15, wherein
the heat generating element has an interlayer structure formed of the material including the carbon-based substance.

17. The image fixing device according to claim 16, wherein
the heat generating element has a resistance change rate value falling within a range of 1.2 to 3.5, the resistance change rate value being obtained by dividing a resistance value in a state where lighting equilibrium is reached by energization by a resistance value in a state without energization, the heat generating element having a positive temperature coefficient characteristic in which a heat generating element temperature and a resistance value are proportional to each other.

18. The image fixing device according to claim 17, wherein
the heat generating element is a thin membrane element having a thickness of equal to or smaller than 300 μm.

19. The image fixing device according to claim 17, wherein
the heat generating element is a lightweight membrane element having a density of equal to or smaller than 1.0 g/cm³.

20. The image fixing device according to claim 17, wherein
the heat generating element is formed of a material having a thermal conductivity of equal to or greater than 200 W/m·K.

21. The image fixing device according to claim 17, wherein
the heating element includes a container that accommodates the heat generating element and part of a power supply portion supplying electric power to opposing both ends of the heat generating element, the container being structured to have its inside filled with an inert gas and to be sealed at the power supply portion.

22. The image fixing device according to claim 17, wherein
the heating element is provided with a reflection portion for defining a heating region to be heated by the heat generating element.

23. The image fixing device according to claim 17, wherein
the heating element is provided with the heat generating element in a plurality of numbers, respective center axes in the longitudinal direction of the plurality of heat generating elements being arranged on a straight line so as to be perpendicular to a conveying direction of the recording target member.

24. The image fixing device according to claim 17, wherein
in the heating element, a membrane element is formed with a member that absorbs infrared radiation at a face facing the heat generating element.

25. The image fixing device according to claim 17, wherein
a heated range heated by the heat generating element includes a nip portion being a pressed site of the recording target member pressed by the heating element and the pressurizing element, and a site located upstream relative to the nip portion in a conveying direction of the recording target member.

26. An image forming device comprising the image fixing device according to claim 15.
